(19) United States
(12) Patent Application Publication
(10) Pub. No.: US 2002/0027859 A1
(43) Pub. Date: Mar. 7, 2002

(54) Data recording method, data reproducing method, data recording apparatus and data reproducing apparatus

(75) Inventors: Osamu Kawamae, Yokohama (JP); Taku Hoshizawa, Yokohama (JP); Shigeki Taira, Yokohama (JP); Yukari Katayama, Yokohama (JP); Makoto Miyamoto, Tokyo (JP); Toshifumi Takeuchi, Yokohama (JP)

Correspondence Address: McDermott, Will & Emery, 600 13th Street, N.W., Washington, DC, 20005-3096, US

(73) Assignee: HITACHI, LTD.

(21) Appl. No.: 09/935,657

(22) Filed: Aug. 24, 2001

(30) Foreign Application Priority Data
May 29, 2001 (JP) 2001-160701
Sep. 4, 2000 (JP) 2000-271520
Nov. 17, 2000 (JP) 2000-355629

(51) Int. Cl. G11B 7/00

(52) U.S. Cl. 369/59.25

(57) ABSTRACT

A data recording and reproducing method and apparatus with which a stable reproduced signal output can be obtained even when overwriting is carried out repeatedly. When recording data to a rewritable recording medium, in scrambling a first data unit 304, scrambling data 12 is prepared using an initial value 13 generated from random numbers and the first data unit 304 is scrambled with this so that the writing data to be written to the recording medium is converted to data different from the data already recorded in the same position on the recording medium. At this time, the initial value from random numbers used to generate the scrambling data is embedded in a reserve area of the recording medium and at the time of reproduction this is used to carry out descrambling. Desired additional information is also included in the initial value and recorded therewith.

### BACKGROUND OF THE INVENTION

1. Field of the Invention

This invention relates to technology for recording and reproducing information to and from an information recording medium, and particularly to technology for recording and reproducing information to and from an information recording medium which can be rewritten multiple times, like a phase-change optical disc.

2. Description of the Related Art

In recent years, phase-change optical discs such as 2.6 GB DVD-RAM, 4.7 GB DVD-RAM and 4.7 GB DVD-RW discs have been marketed, and recording technology in this field is tending toward higher and higher densities.

With information recording medium such as DVD-RAM and DVD-RW discs, unlike medium such as CD-R discs on which data can be written only once, data can be written multiple times.

However, although DVD-RAM discs and the like have the characteristic that they can be written to multiple times, there are problems associated with such repeated writing.

For example, deterioration of the disc material caused by repeated writing to the same place on the disc may make it impossible for data recording to be carried out normally and for reproduction processing to be carried out normally. As a way of solving this problem, the kind of method shown in Japanese Unexamined Patent Publication No. H.10-49872 has been used.

These issues may become more problematic as densities increase.

One cause of this problem is as follows. For example in present phase-change recording methods wherein a recording film is melted at the time of information recording, when data writing is repeated, the viscosity of the melted parts of this recording film decreases and the recording film flows in a certain direction, with the result that the thickness of the recording film changes from place to place. The amplitude center level and the amplitude of the reproduced signal depend greatly on the thickness of the recording film. The size of the fluctuation of the amplitude center level and the amplitude of the reproduced signal caused by recording film thickness variation readily becomes greater than the level of the reproduced signal from the shortest mark, leading to a signal error detection. Consequently, a distortion corresponding to the recording film thickness arises in the reproduced signal and gives rise to jitter. When the same information is written to the same place multiple times, because the writing pattern is the same pattern, this phenomenon appears markedly.

This issue may become more problematic with increasing density.

Also, in these recording medium, as data is recorded, there are numerous requirements to record additional information, for example an identification code relating to the time of the recording and the content recorded, and associated information relating to the recorded data such as information relating to copyright, and to perform various kinds of control and services using this additional information. And to record these pieces of information, a recording area for that purpose is needed on the disc, and this reduces the space available for recording data.

### SUMMARY OF THE INVENTION

It is therefore an object of the present invention to solve these problems and prevent local changes in the film thickness of the recording film and thereby make possible good recording and reproduction, and to provide a method of writing data to a recording medium by which additional information can be recorded effectively and also a way of using this method to record additional information associated with data and a way of reproducing this additional information.

Although DVD-RAM discs and the like have the characteristic that they can be rewritten multiple times, because deterioration of the disc material caused by repeated writing to the same place on the disc may make it impossible for data recording to be carried out normally and for reproduction processing to be carried out normally, recording is carried out with different data every time being superposed on the data to be recorded so that the data written is made different every time. To make the data different every time, an initial value is varied to generate different scrambling data every time, and this scrambling data is superposed on the data to be recorded. Furthermore, additional information is embedded in the initial value at this time and recorded together with the data.

To achieve this, in the present invention:

(1) A data recording apparatus of a rewritable recording medium is provided with converting means for converting data to be written to the recording medium into data different from data recorded in the same position on this recording medium, and data for making this conversion is recorded on the recording medium.

(2) In (1) above, the data for making the conversion is changed so as to superpose on the data to be written other data having no correlation therewith and change it into different data every writing operation.

(3) In (2) above, the data superposed on the data to be written is generated as a pseudo-random number data sequence and for every writing operation an initial value for generating the pseudo-random numbers is altered and the altered initial value is written to the recording medium.

(4) Additional information is embedded in a specified position in the initial value and generated.

(5) In a method for reproducing data from a rewritable recording medium, data reproduction is carried out via a data conversion step of reverse-converting reproduced data, from data based on a reverse conversion recorded on the recording medium, and detecting additional data embedded in the data based on conversion.

(6) Reproduction processing is controlled in accordance with additional information detected from information based on the reverse conversion of the data.

### BRIEF DESCRIPTION OF THE DRAWINGS

FIG. 1 is a block diagram illustrating a preferred embodiment of the invention;

FIG. 2 is a view illustrating a processing sequence for preparing recording data;

FIG. 3 is a view showing the constitution of a data sector shown in FIG. 2;

FIG. 4 is a view showing the constitution of identification data (a sector ID) shown in FIG. 3;

FIG. 5 is a view showing the constitution of a reserve area RSV shown in FIG. 3;

FIG. 6 is a table showing initial values of a shift register for data to be used for scrambling;

FIG. 7 is a view showing the construction of a feedback shift register for generating scrambling data;

FIG. 8 is a view showing the constitution of an ECC block shown in FIG. 2;

FIG. 9 is a view showing the constitution of an ECC block after row-interleaving;

FIG. 10 is a view showing the construction of a third data unit shown in FIG. 2;

FIG. 11 is a view showing an example of a reserve area for recording information on a recording medium in a preferred embodiment of the invention;

FIG. 12 is a view showing an example of the construction of a signal generating circuit for generating scrambling data;

FIG. 13 is a block diagram illustrating another preferred embodiment of the invention;

FIG. 14 is a block diagram illustrating a further preferred embodiment of the invention;

FIG. 15 is a view illustrating an operation of writing sequentially modulated data to a recording medium while applying SYNC codes to the third data unit shown in FIG. 10;

FIG. 16 is a view showing an arrangement of user areas and spare areas on a DVD-RAM disc;

FIG. 17 is a view showing a volume constitution of a DVD-RAM;

FIG. 18 is a view showing an example of the construction of a data sector when an amount of data to be recorded is small;

FIG. 19 is a flow chart showing the flow of an encoding process shown in FIG. 2;

FIG. 20 is a block diagram of an example of the construction of an optical disc recording and reproduction apparatus;

FIG. 21 is a block diagram of a recording and reproduction apparatus illustrating another preferred embodiment of the invention;

FIG. 22 is a view showing an example of the construction of an initial value generating block shown in FIG. 21;

FIG. 23 is a flow chart showing a specific example of an encoding step;

FIG. 24 is a view showing an example of the constitution of a reserve area for recording initial values on a recording medium;

FIG. 25 is a flow chart showing another example of an encoding step;

FIG. 26 is a view showing an example of a method for adding initial values to a third data unit;

FIG. 27 is a view showing an example of a data arrangement of when recorded data is to be rewritten only in part;

FIG. 28 is a view illustrating another example of a method for adding initial values to a third data unit;

FIG. 29 is a view showing another example of the construction of an initial value generating block;

FIG. 30 is a view showing still another example of the construction of an initial value generating block;

FIG. 31 is a view illustrating an example of data made up of a succession of ECC block units;

FIG. 32 is a view showing still another example of a scrambling method in the invention;

FIG. 33 is a view showing an example of the construction of guided scrambling shown in FIG. 32;

FIG. 34 is a view showing an example of the construction of a decoder of the guided scrambling of FIG. 32;

FIG. 35 is a view showing data constitutions in scrambling and descrambling in the invention;

FIG. 36 is a block diagram showing an example of a system for controlling reproduction output from the reproduction system shown in FIG. 21;

FIG. 37 is a block diagram showing an example of a system for performing recording control according to a preferred embodiment of the invention;

FIG. 38 is a block diagram showing an example of the constraction of reproduction and recording processing according to a preferred embodiment of the invention in a case where the same format is used throughout; and

FIG. 39 is a block diagram showing an example of the construction shown in FIG. 36 made into an integrated circuit.

### DETAILED DESCRIPTION OF THE PREFERRED EMBODIMENTS

First, the main numbers used in the drawings will be explained. 12 scrambling data, 13 . . . initial value, 301 . . . ID data, 302 . . . ID+IED, 305 . . . first data unit, 307 . . . second data unit, 308 . . . third data unit.

Preferred embodiments of the invention will now be described, for the case of a DVD, with reference to the drawings.

Firstly, the format of a recording data area of a DVD-RAM will be described.

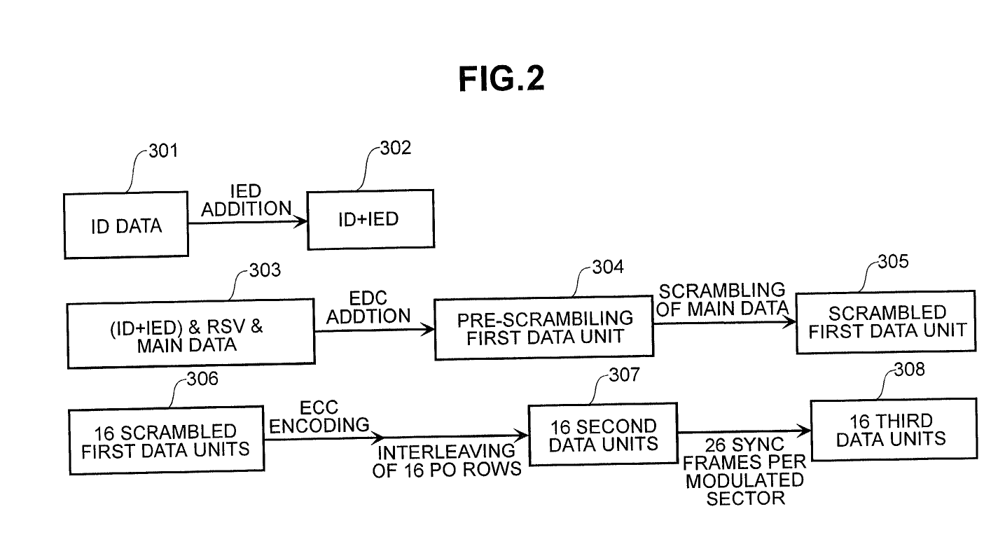

FIG. 2 is a block diagram illustrating a processing sequence for preparing recording data.

The data will be called first data unit 305, second data unit 307 and third data unit 308 in accordance with the stage it has reached in signal processing, and processing for preparing the recording data is carried out in accordance with the processing sequence (flow of encoding) shown in FIG. 2.

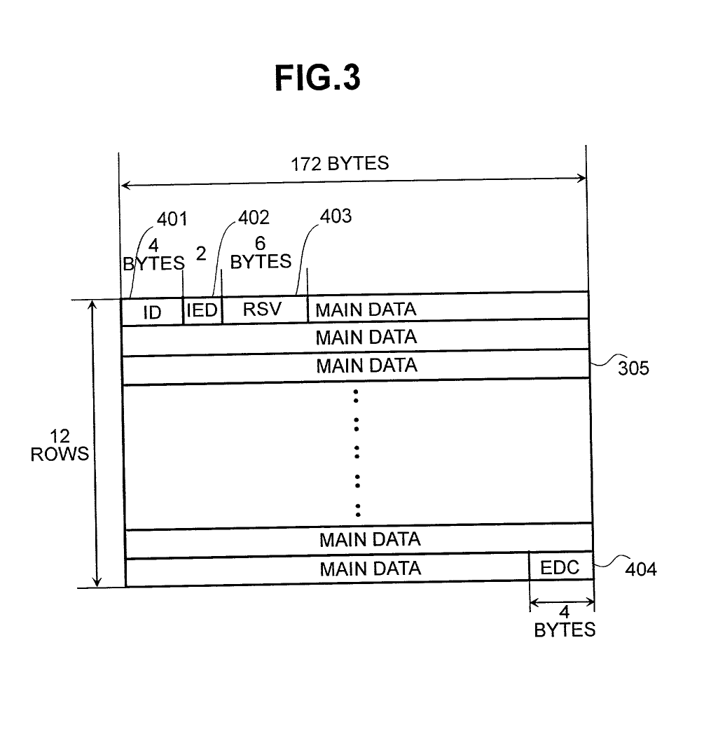

FIG. 3 shows the constitution of a first data unit 305.

A first data unit 305, as shown in FIG. 3, is 2064 bytes of data made up of 2048 bytes of main data; 12 bytes of i.d. address information, including sector identification data (sector ID); and 4 bytes of error detection code (EDC), and consists of 12 rows of 172 bytes. Within the 12 bytes of i.d. address information is a 6-byte RSV (Reserve), shown in FIG. 2 is added. After EDC computation, scrambling data is applied to the 2048 bytes of main data in the first data unit 305. Also, across 16 first data units 305 making up an ECC (Error Correction Code) block, Cross-Reed-Solomon error correction code encoding is carried out. Second data units 307 are obtained by adding PO (Parity of Outer code) and PI (Parity of Inner code) and interleaving after the ECC encoding. PO and PI are generated within the ECC block formed by 16 of the first data units 305. A third data unit 308 is a second data unit 307 with a synchronization signal (SYNC code) applied to the head of every 91 bytes.

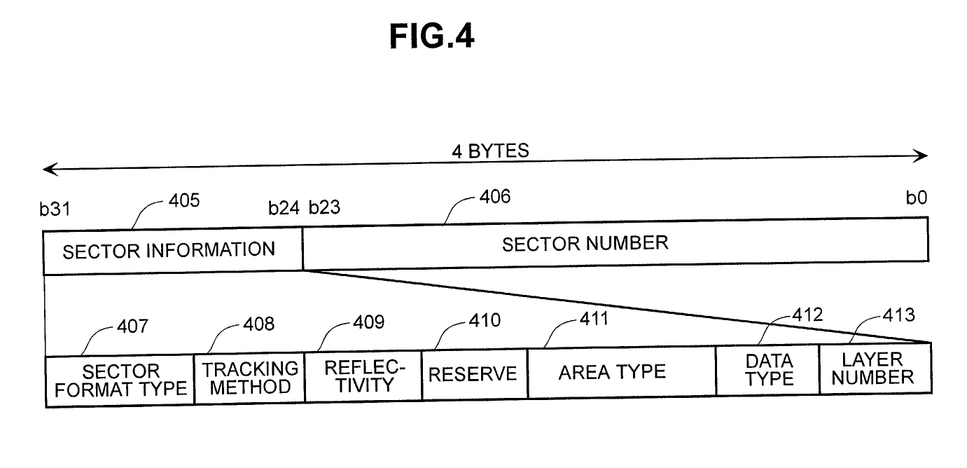

FIG. 4 is a diagram showing an example of the identification data ID (sector ID) 401.

In the figure, the identification data ID 401 is made up of 1 bytes of sector information (data field information) and a 3 byte sector number (data field number).

The sector information 405 includes sector format type information 407 for the disc, tracking method information 408 and reflectivity information 409 or the like. Also included are area type information 411 expressing data areas and lead-in/lead-out areas, data type information 412 expressing whether reproduction-only data or addition/overwrite data, and layer number information 413 expressing a layer of the disc. The sector number 406 is a serial number assigned to the data area, and the data areas are allocated with 030000h as the head. The EDC 404 in FIG. 3 is a check code attached to the 2064-byte data unit before scrambling. With this EDC code 404, it is checked whether scrambling is correct and, after error correction is carried out, whether an erroneous correction has been made.

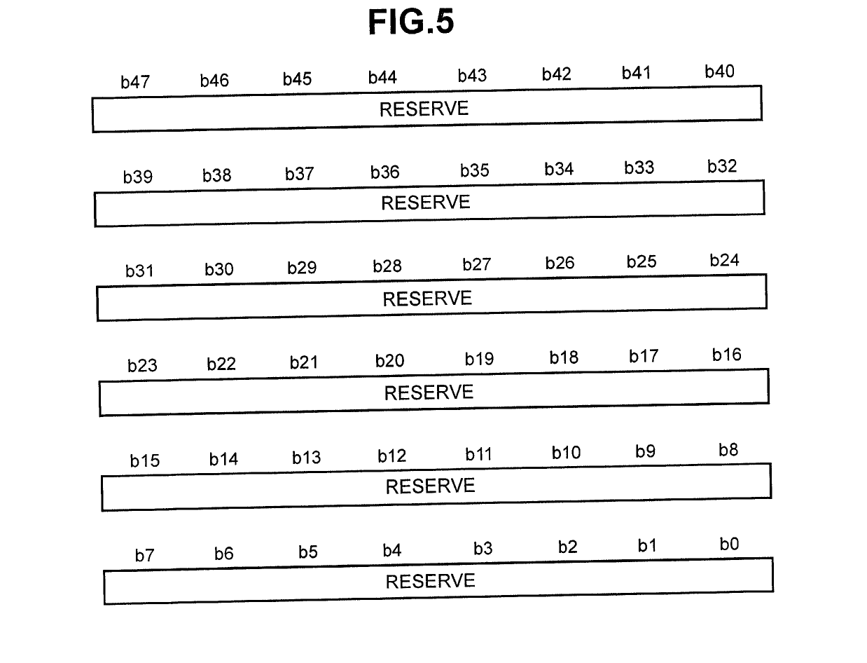

FIG. 5 is a view showing an example of the RSV 403 of the data area in FIG. 3. As shown in the figure, presently all 48 bits are reserve.

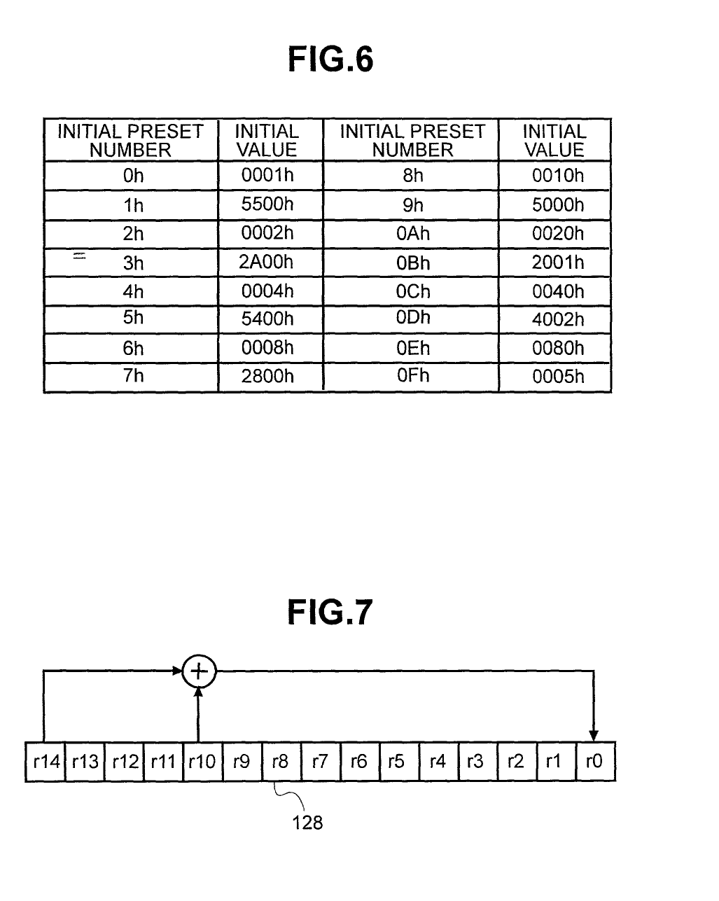

FIG. 6 shows initial values of a shift register, and FIG. 7 shows a circuit for generating scrambling data for scrambling the main data. The scrambling data is generated using the initial values shown in FIG. 6. The initial preset numbers in FIG. 6 correspond to the 4 bits that are b7 through b4 of the sector ID. That is, if the sector ID does not change, the same scrambling data will be generated.

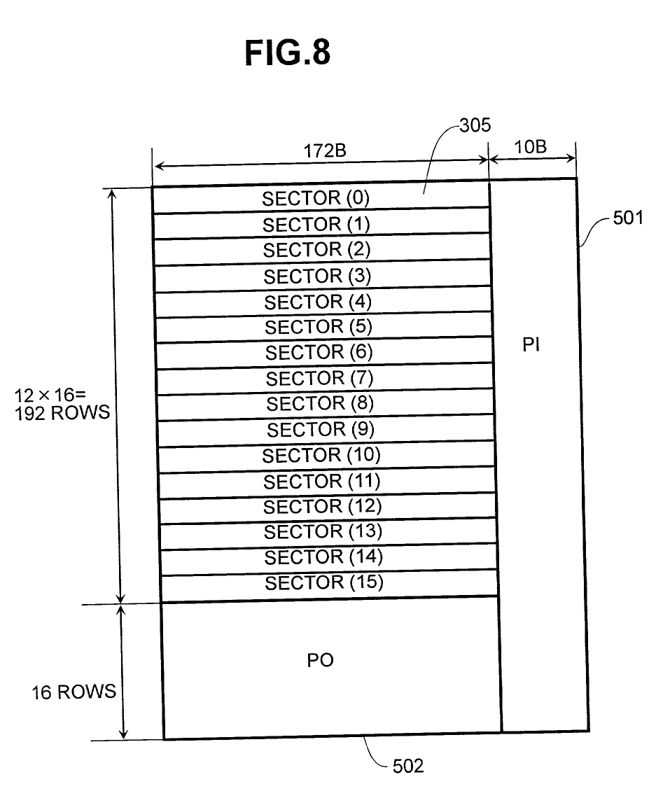

FIG. 8 is a view showing an example of the constitution of an ECC block.

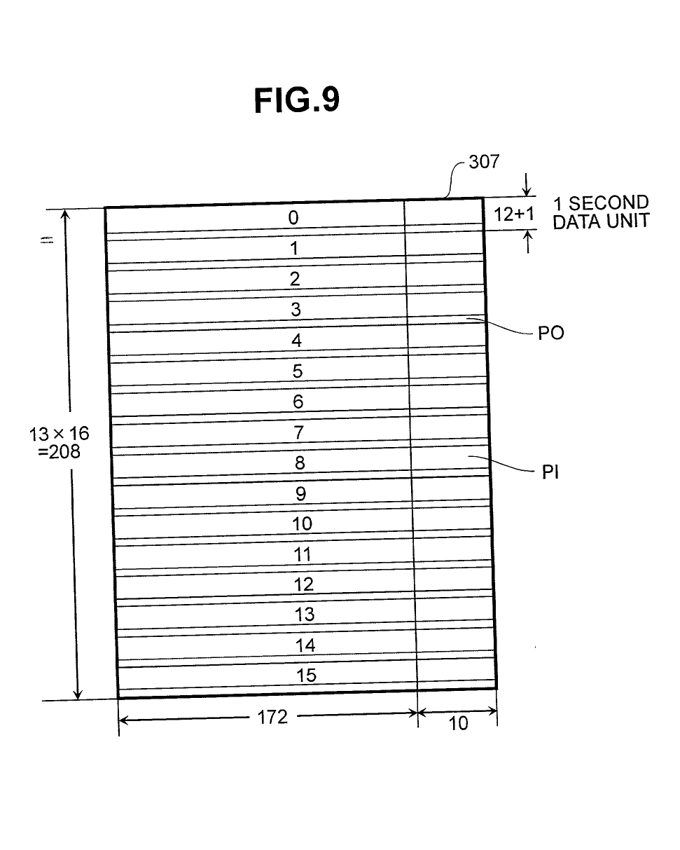

In this figure, the ECC block is made up of 16 “data sectors” 305 scrambled as an information field. With 172 bytes×192 rows, equivalent to 172 bytes×12 rows×16 (data sectors), as an information field, 16 bytes of outer code parity PO 502 are added to each of the 172 columns to form a Reed-Solomon RS (208, 192, 17) outer code. Then, 10 bytes of inner code parity PI 501 are added to all of the 208 rows (=192 rows+16 rows), including the PO 502, to form a Reed-Solomon RS (182, 172, 11) inner code. The ECC block shown in FIG. 8 is interleaved and modulated and recorded on the disc. After this interleaving, as shown in FIG. 9, the 16 rows of outer code parity PO are inserted one row at a time every 12 rows of the data area. Each of the 13-row×182-byte parts inside the ECC block after the row-interleaving is called a second data unit 307, as mentioned above, meaning that the ECC block after row-interleaving is made up of 16 of these second data units 307.

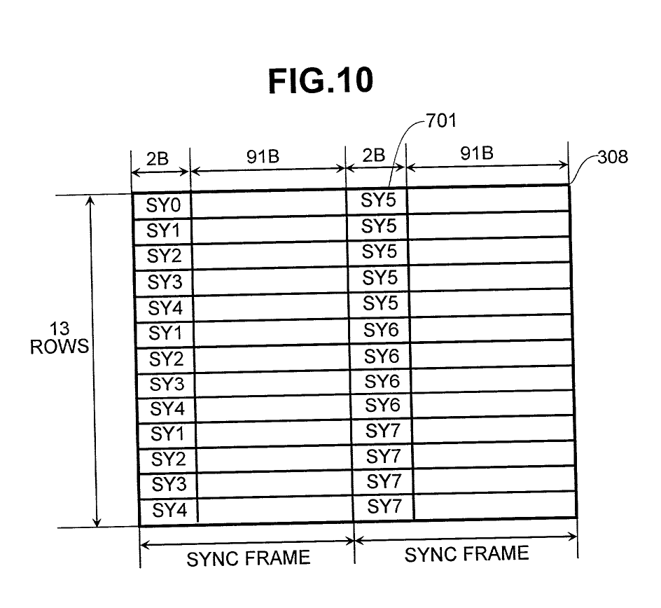

FIG. 9 is a view showing an example of the constitution of an ECC block after row-interleaving. In this figure, by sequentially modulating the interleaved 13-row×182-byte (=2366-byte) second data units 307 one row at a time from the 0th row while adding 2 SYNC codes (synchronization codes) before the 0th and 91st columns, it is possible to construct third data units 308. As shown in FIG. 10, 1 third data unit is made up of 13×2 SYNC frames, and consists of (2B+91B)×13 rows×2×16 (no. of bits per byte)=38688 channel bits. It is recorded on the disc further 8/16-modulated to convert 8 bit input data to 16 channel bit code. The SYNC code combination is made as shown in FIG. 10. The head of each third data unit can be specified by SY0 (SYNC code “0”) and each rows is specified by SY1 through SY4, which repeat cyclically, and SY5, SY6 and SY7. Error correction is carried out on groups of 16 third data units: the ID information following the SY0 of each third data unit 308 is read in, and the head of the block is recognized at each address divisible by 16. Consequently, SY0, i.e. the head of a third data unit, is important in the decoding of the data. And in the kind of sector structure shown in FIG. 10, because rows can be specified, if several rows are read, by using their cyclicality it is also possible to predict the position of SY0.

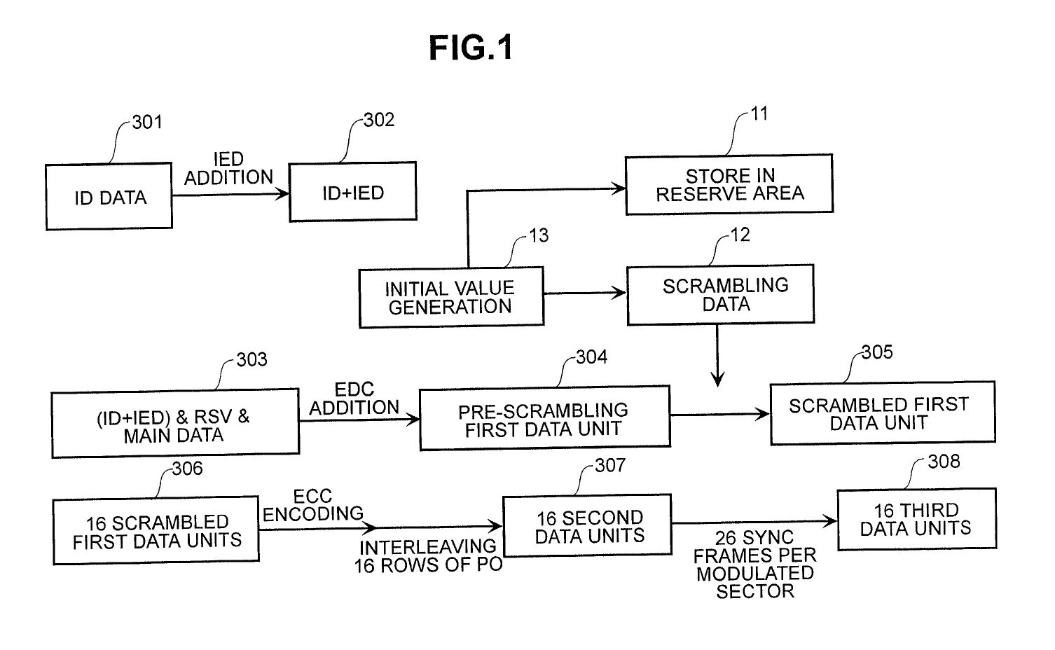

FIG. 1 shows a preferred embodiment of the invention applied to a recording method for encoding and recording data. Elements in FIG. 1 having the same reference numeral as in FIG. 2 have the same construction/function as their counterpart in FIG. 2.

This preferred embodiment is a method which up to the first data unit 304 before scrambling is the same as the related art shown in FIG. 2 but in which, with respect to the processing for applying scrambling data to the main data in the DVD-RAM format shown above, the scrambling data is generated not with an initial value from the sector ID of the kind shown in FIG. 6 but by an initial value 13 in FIG. 1 being randomly generated and used to generate scrambling data 12 to be applied to the main data. The generated initial value is recorded in a reserve area 11 of the recording medium and on reproduction this initial value can be read out and used again to generate the same scrambling data.

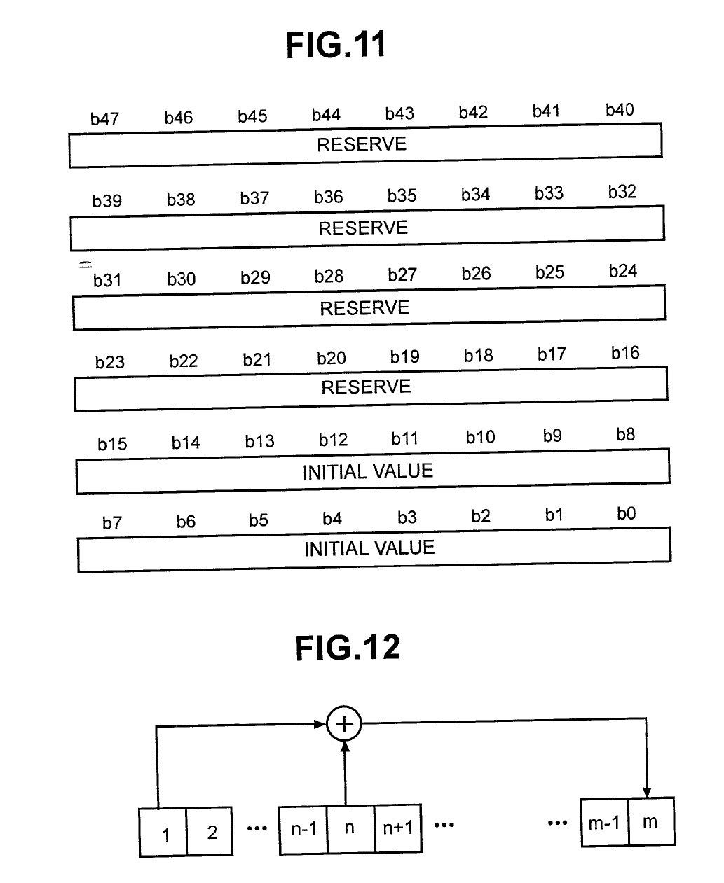

FIG. 11 is a view showing an example of a reserve area for recording information on the recording medium.

FIG. 5 shows a constitution of a reserve (RSV) area wherein all bits from b0 through b47 are secured as system reserve area. With respect to this, the example shown in FIG. 11 is an example wherein of these the 16 bits of b0 to b15 are used to provide an area for recording an initial value of scrambling data. Here, although in this preferred embodiment the area for recording the initial values was made the 16-bit area of b0 through b15, the invention is not limited to this, and it is only necessary that it is possible for an initial value of scrambling data to be recorded in at least one location within the block to which it relates. And, the area for recording the initial value of the scrambling data is not limited to this CPR-MAI, and can be any data-recordable area. The initial value itself has attached to it a check code for checking whether the correct initial value has been read out.

FIG. 12 is a view showing an example of the construction of a signal-generating circuit for generating scrambling data.

This example is called an M-series signal-generating circuit, and by deciding a shift register length (m) and a tap number (n) a signal with a relatively long period can be generated and this can be used as a pseudo-random number. Multiple EXORs may be provided. Preferably, to reduce the likelihood of the same data being generated, the generation of this scrambling data is not reset even when the power supply is cut, and it is constantly updated from the time it is first set.

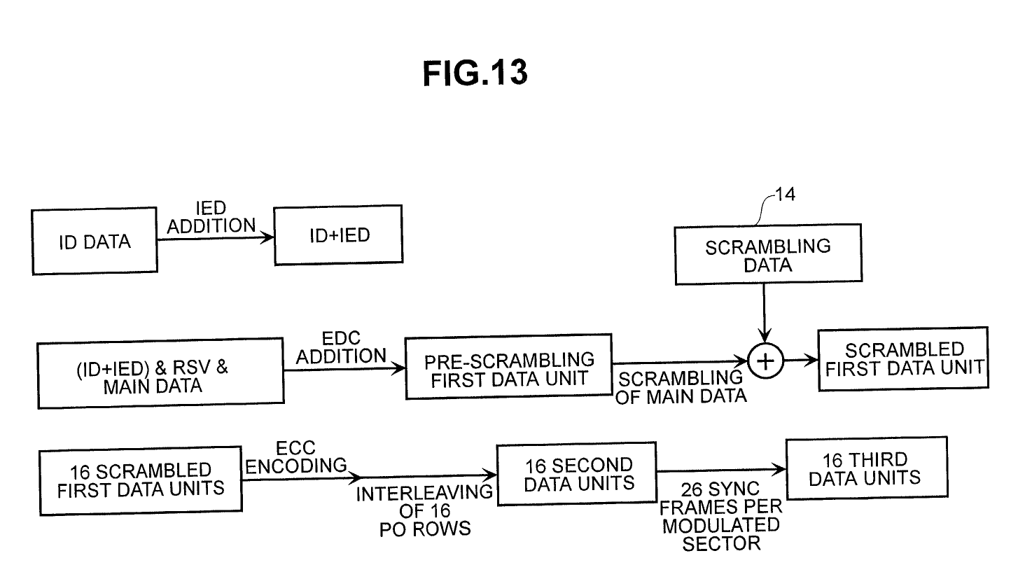

FIG. 13 is a view illustrating another preferred embodiment of the invention.

This preferred embodiment is a method wherein separate scrambling data 14 is further applied to the related art format shown in FIG. 2. This approach can be adopted just by adding just the addition of new scrambling data, without changing the circuit used for the related art approach. At this time, because the newly generated scrambling data must be made different from the related art scrambling data, the shift register length and tap number are made different from those of the related art scrambling data generating circuit. The initial value of the scrambling data may be generated using random numbers which change every time recording is carried out, and for example when the first 2 bytes (16 bits) of user data are used an area for newly storing the initial values becomes unnecessary.

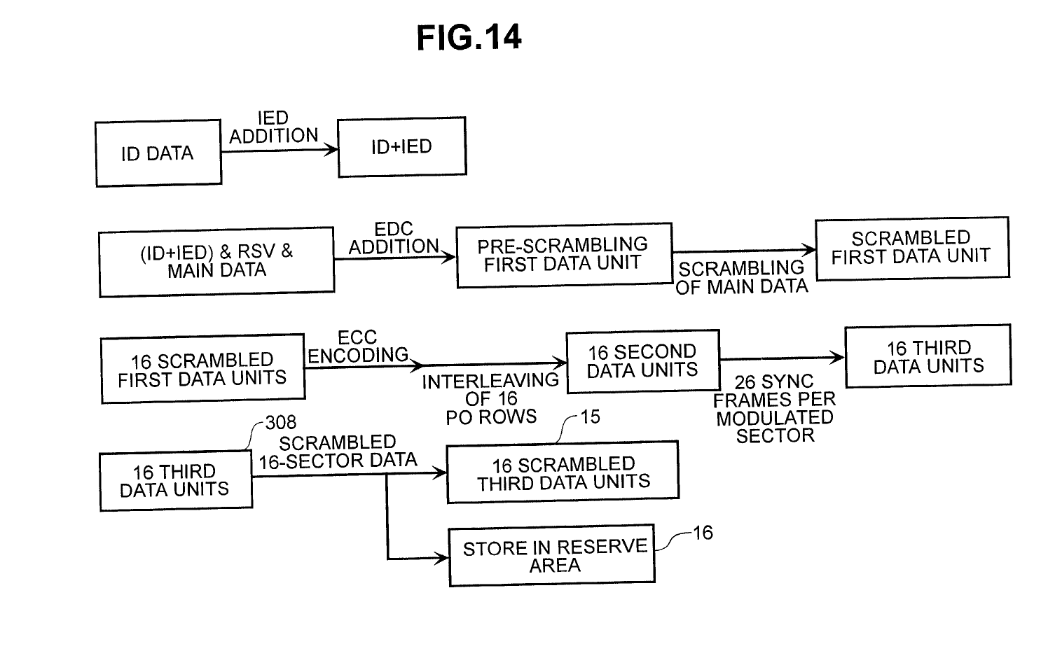

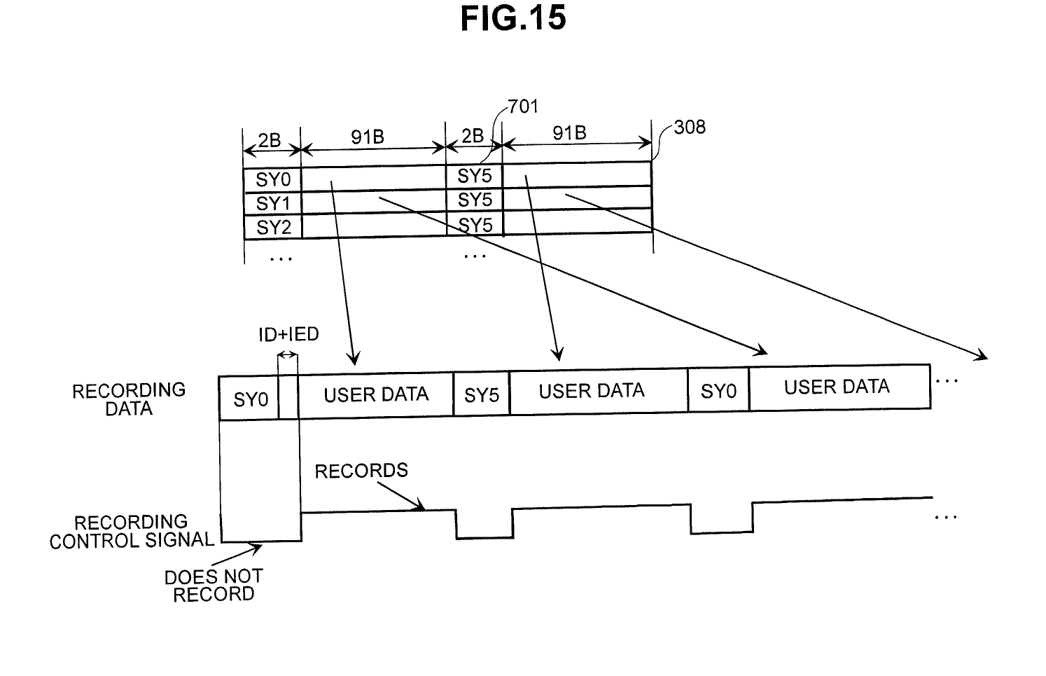

FIG. 14 is a view illustrating another preferred embodiment of the invention.

This preferred embodiment is a method wherein separate scrambling data is further applied after third data units 308 have been constructed in sets of 16 in accordance with the related art format shown in FIG. 2. The result of the addition is 16 scrambled third data units 15. This approach can be adopted just by adding the addition of new scrambling data to an integrated circuit used for the related art approach, without changing the integrated circuit output. And the initial value of the scrambling data is stored in a reserve area 16. At this time also, because the newly generated scrambling data must be made different from the related art scrambling data, the shift register length and tap number must be made different from those of the related art scrambling data generating circuit.

FIG. 15 is a view showing an operation of applying SYNC codes to the third data unit 308 shown in FIG. 10 while writing sequentially modulated data to a recording medium.

Different data is written in the user data parts, as described above, but as the SYNC and the sector ID and IED (ID Error Detection code) in the user data the same data is written every time. Therefore, when writing to the recording medium these parts are not overwritten, and only the writing data which has changed is recorded. Here, only SYNC, sector ID and IED have been shown, but other than this also, when writing data is little changed, by control being performed like this, unnecessary overwriting is not carried out. And, when before data is written, the previously written data is known, as shown here, control is so performed that the parts where the data has not changed are not overwritten and only the parts where the writing data is different are recorded. By this means it is possible to reduce damage caused by writing. FIG. 15 is an example of writing control in data units within frames having SYNC at their head, but the invention is not limited to this, and writing control may be carried out in some other suitable units, such as for example frame units, sector units, ECC block units or bit units.

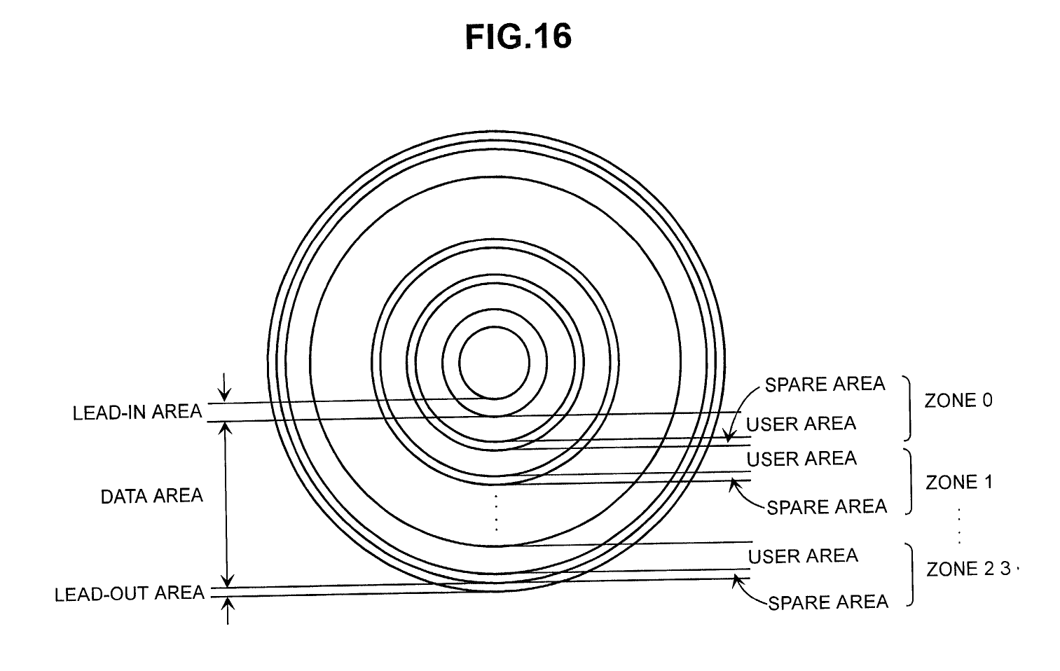

FIG. 16 is a view showing an arrangement of user areas and spare areas on a DVD-RAM disc.

As shown in the figure, the disc area is primarily divided into a lead-in area at its inner periphery, a data area and a lead-out area at its outer periphery, and of these, the data area is divided into zones, zone 0 to zone 23, each made up of a user area and a spare area. In a DVD-RAM, to secure reliability of data, when there is a defect in the disc, to compensate for that, a spare area is provided with each user area. Information on the defect is recorded twice at each of the tail of the lead-in area and the head of the lead-out area. This kind of defect list is updated every time defect compensation processing is carried out, and because apart from the newly added defect the writing data does not change, as in the example described above only the changed parts of the writing data are recorded.

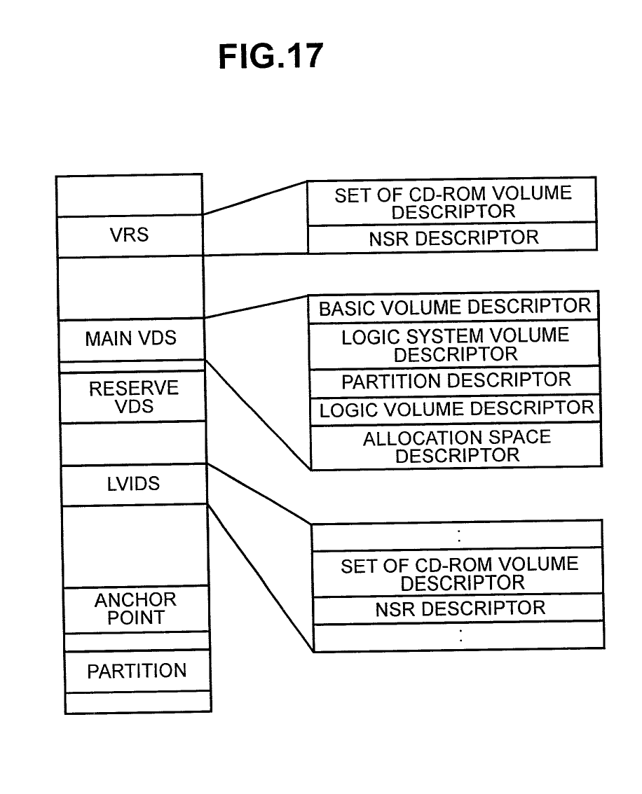

FIG. 17 is a view showing the volume structure of a DVD-RAM.

In the figure, there are VRS (Volume Recognition Sequence), VDS (Volume Descriptor Sequence) and LVIDS (Logical Volume Integrity Descriptor Sequence) in the volume structure. VRS manages standard extensions, and in a DVD-RAM a standard identifier NSR02 prescribed by ISO/ICE 1344 is recorded. VDS manages the volume structure, LVIDS manages obstacles arising in logical volumes, and recovery information after trouble is recorded. In the volume management information, there are fields which are overwritten every time one file is overwritten, and these are always overwritten every time, in connection with whatever kind of operation involving writing, such as file creation/updating/deleting/copying. Consequently, this area undergoes the largest number of file overwrites, and damages the disc. Because of this, here also, control is so performed that parts where the data has not changed are not overwritten, and only the parts where the writing data has changed are recorded. And the management information is also scrambled and the writing data is made different every time. By this means, it is possible to reduce damage caused by writing. And, these pieces of management information are not overwritten every time there is an operation, but are once held in memory inside the apparatus and overwritten at the time of a disc change or when the power supply is switched off or when data is saved at predetermined intervals, to reduce the number of overwrites. If the management information of one state before is held in memory and left, even when the management information was not written correctly, recovery can be achieved.

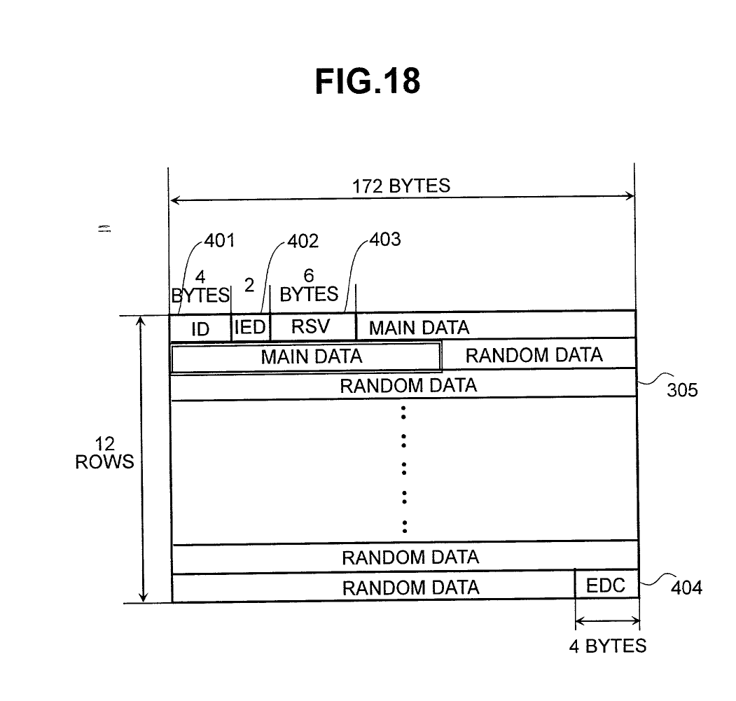

FIG. 18 is a view showing an example of the constitution of a data unit of when the amount of data to be recorded is small.

Because the data is converted into 2064 bytes of data made up of 2048 bytes of main data and 12 bytes of i.d. address information such as the sector ID and 4 bytes of error detection code (EDC), as shown in FIG. 3, when the amount of data to be recorded is less than 2048 bytes, the data of parts other than the main data does not change, and even after the scrambling data illustrated by FIG. 6 and FIG. 7 is superposed thereon it becomes the same data as the previous time. Because of this, when the amount of data to be recorded is less than 2048 bytes, known random data is added to make it up to 2048 bytes.

Here, assuming that it very rarely happens that the amount of data to be recorded is exactly the same as it was the time before, only one known random data sequence is needed, and when that data series has arisen, subsequent data can be treated as unwanted data. And, because as shown in FIG. 8 the data to be recorded is made up in groups of 16 data units, in the same way as in the example shown above, when the amount of data to be recorded is small, by embedding known data the same effects can be obtained. By doing this, it is possible to prevent the same data being written in the same place without newly making an area for recording the initial value of a random data series.

In the preferred embodiment described above, the case of a DVD recording medium was described; however, the invention is not limited to this and can be applied to any information recording medium with which information recording is carried out by melting a recording film with heat from irradiation with an energy beam and changing its atomic arrangement. Also, the present invention can be applied when the recording medium is an optical card or the like. And as the beam used to produce heat and melt a recording film for recording, the invention is not limited to a laser beam and can be applied with any energy beam capable of melting a recording film. And when the beam is a laser beam, the wavelength and type of the laser beam are not limited by the invention. When a relatively short-wavelength laser such as a blue laser or an ultraviolet laser is used, high-density recording can be realized easily.

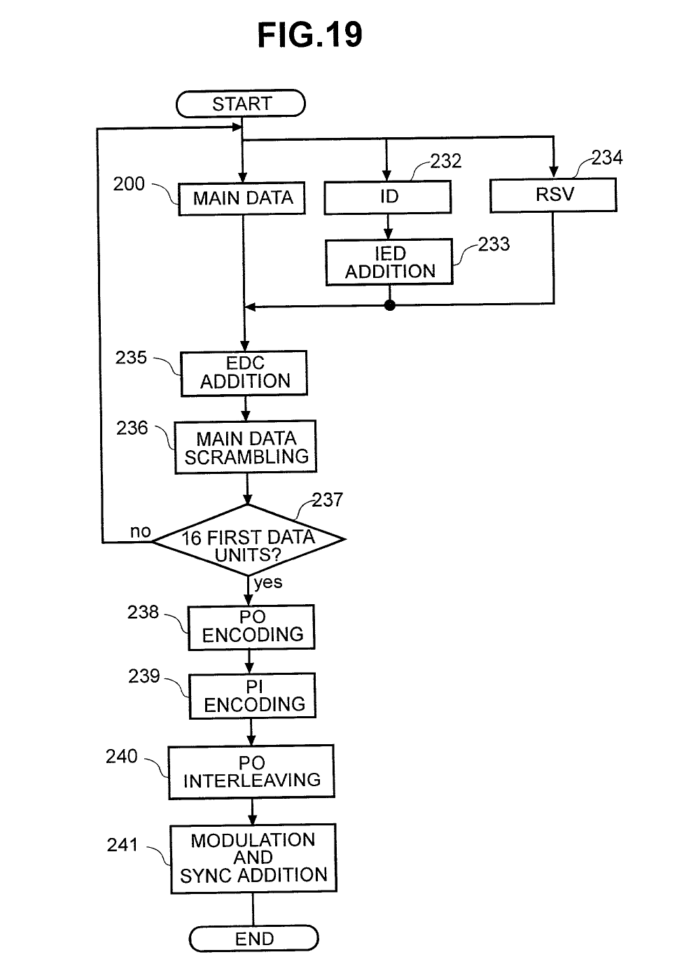

FIG. 19 is a flow chart showing a flow of encoding processing shown in FIG. 2.

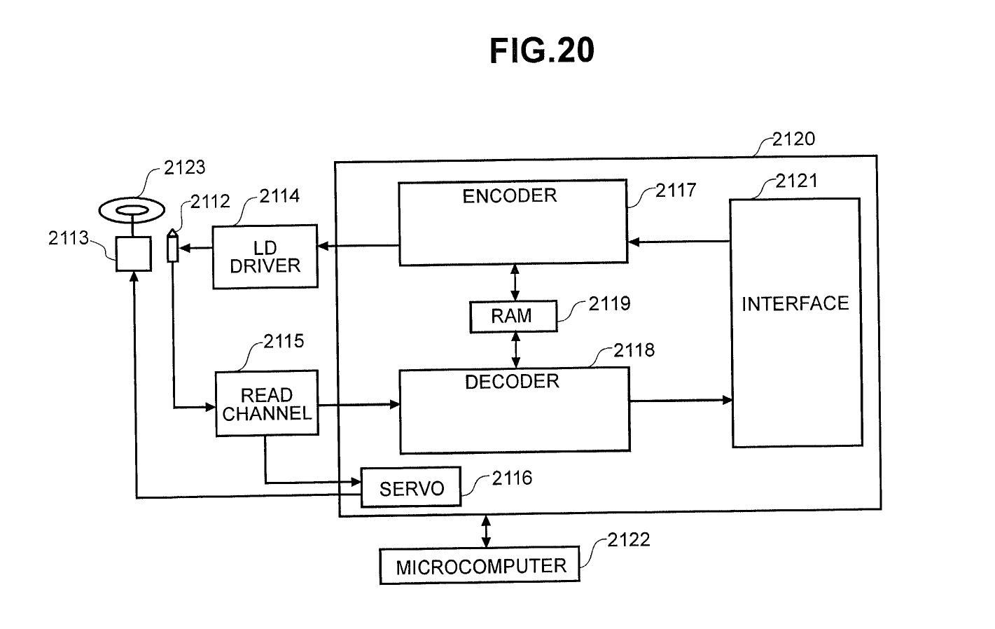

FIG. 20 is a block diagram showing an example of the construction of an optical disc recording and reproducing apparatus, in this case a DVD-RAM drive.

In FIG. 20, 2123 denotes an optical disc; 2112 an optical pickup for reading data recorded on the optical disc 2123; 2113 a spindle motor for rotating the disc; and 2114 a laser driver. A servo 2116 controls the optical pickup 2112 or the like. A read channel 2115 performs waveform equalizing, binarization and synchro clock generation on an analogue reproduction signal read out from the disc 2123; a decoder 2118 performs processing such as demodulation and error correction on the data read out; and a RAM 2119 temporarily stores the data. An encoder 2117 performs processing such as modulation and error correction code addition when data is being written. The reference number 2120 denotes an integrated circuit for digital signal processing; 2121 an interface for performing data input-output control with respect to higher devices; and 2122 a microcomputer which controls the system.

Since this construction uses the example of a DVD drive to be connected to a personal computer, the interface 2121 also means a connection to a personal computer, and is mentioned as an example of connection to an MPED (Moving Picture Experts Group) board or a HDD (Hard Disc Drive). Of course, the construction of a recording and reproducing apparatus is not limited to this, and a device to which it is connected may be a receiver such as a STB (Set Top Box) or some other picture/sound recording and reproducing device and is not particularly limited. The encode processing for making the third data unit 308 shown in FIG. 2 is carried out by the encoder 2117. Parts of the present invention relating to signal processing relate particularly to the processing carried out by the encoder 2117 and the decoder 2118. A method and apparatus for this processing will now be described.

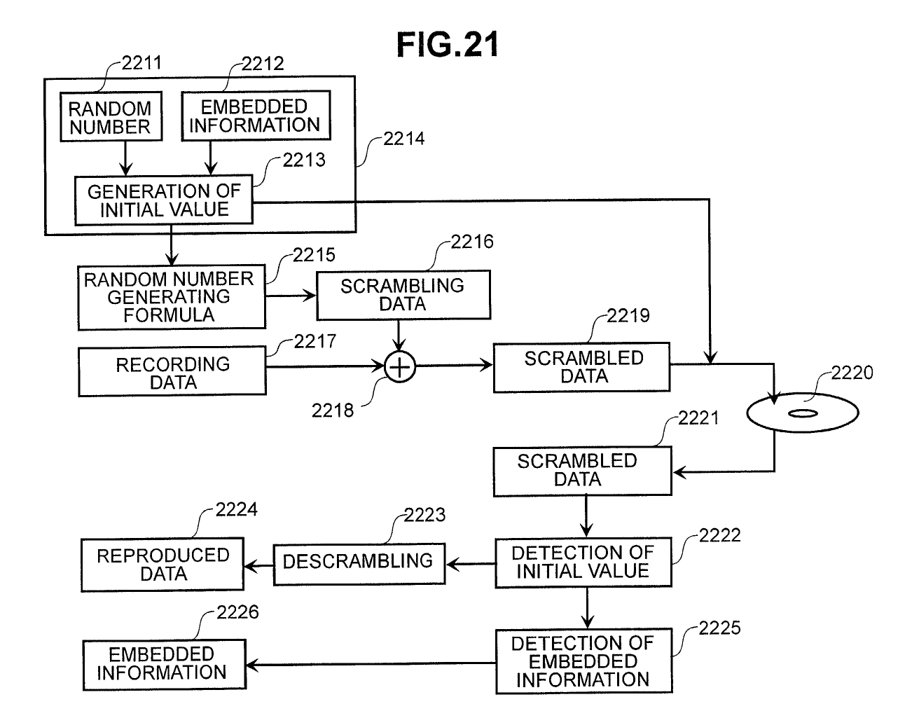

FIG. 21 illustrates a preferred embodiment of a method according to the invention wherein recording data is scrambled and additional information is embedded in initial values of the scrambling and also recorded on the recording medium, and on reproduction the additional information is detected from the scrambled data and the initial values.

In FIG. 21, the reference number 2211 denotes a random number, and 2212 denotes embedded additional information relating to recording data such as copyright information. An initial value 2213 is generated from the random number 2211 and the embedded information 2212, and these blocks collectively will be called the initial value generating block 2214. A predetermined random number generating formula 2215 generates scrambling data 2216 on the basis of an initial value generated by the initial value generating block 2214. Here, in the initial value generating block 2214, when data is being recorded, an initial value is generated for a predetermined unit of recording data to randomize the recording data. In related art, as shown in FIG. 6, for the initial value of a shift register, because the initial preset number corresponds to the 4 bits of b7 through b4 of the sector ID, if the sector ID does not change, then the scrambling data also will be generated as the same data. Because the sector ID corresponds to an address on the disc, in the same place on the disc the same, scrambling data is always generated and when the main data is the same, the same data is recorded on the disc every time. To avoid this, it is necessary to write with different data every time.

The reference number 2217 denotes recording data. Preceding and subsequent error correction parity generation and modulation for recording are not shown in the figure. An adder 2218 superposes the scrambling data 2216 on the recording data 2217, and the scrambled data 2219 resulting from this summation and information based on the initial value generated by the initial value generating block 2214 are recorded on a rewritable recording medium 2220 in a predetermined format. Here, a method wherein the data is scrambled by generating a random number series and using this as scrambling data 2216 has been described; however, there are also other methods of generating scrambling data, and as long as it is a system wherein when data is written, scrambling data which is different every time is generated and an initial value of that scrambling data is written to the disc, the invention does not particularly limit the method used.

Next, the reproducing system of FIG. 21 will be described.

Data recorded on the recording medium 2220 is reproduced as data to which scrambling data has been applied (normally demodulation and error correction are included before and after this, but here they are not shown in the figure). From the reproduced scrambled data 2221, the initial value of the scrambling data applied at the time of recording is detected by initial value detection 2222. Here, data for error detection may have been added to the initial value, and in this case the initial value is taken after error detection or correction is carried out. The detected initial value reveals the scrambling data series, and using this descrambling 2223 is carried out and reproduced data 2224 is obtained. Also, from the initial values detected by the initial value detection 2222, embedded information is detected by embedded information detection 2225, and embedded information 2226 is obtained.

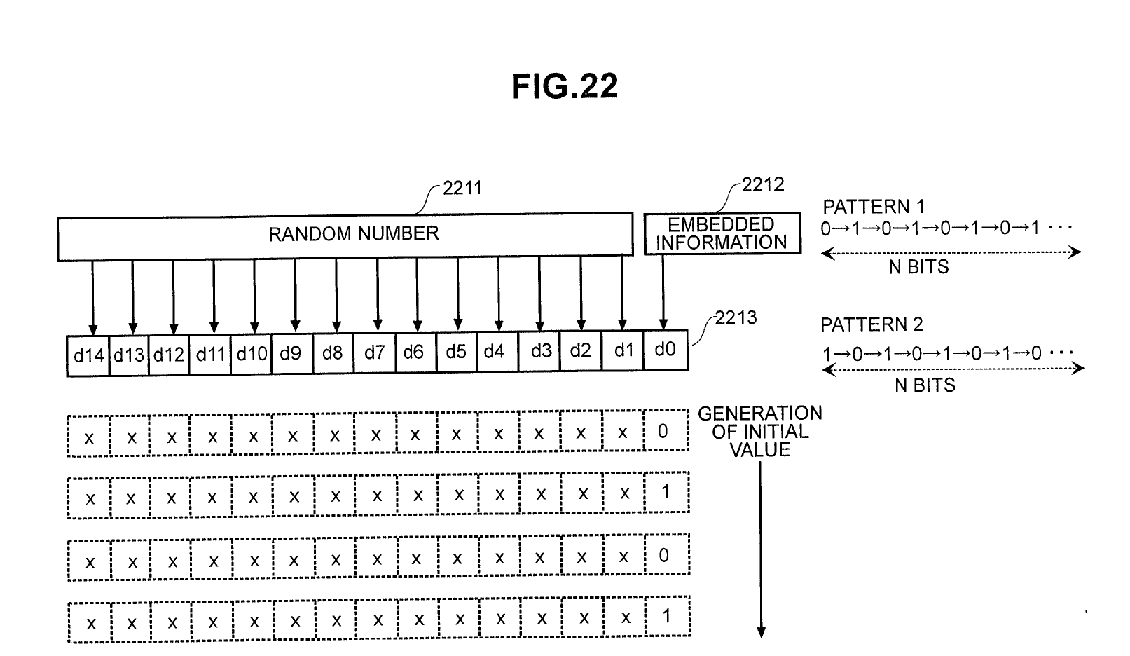

FIG. 22 is a view showing an example of the construction of the initial value generating block 2214 shown in FIG. 21.

Here, the case of embedding embedded information in a least significant bit d0 when a 15-bit initial value is to be generated will be shown; however, the number of bits of the initial value and the location, length and pattern of the embedded bits are not limited to those shown here.

In FIG. 22, every time initial value generation is carried out, a random number 2211 is generated and applied to the 14 bits of d1 through d14. Embedded information is applied as for example a pattern 1 of a series of n bits of data, and the first time “0” is applied and then “1” and then “0”, and so on. As a result, the generated initial values are generated as first “xxx xxxx xxxx xxx0” then “xxx xxxx xxxx xxxl1” then “xxx xxxx xxxx xxx0”, and so on (where x indicates either “0” or “1”). When n initial values have been generated like this, a series of n bits of data is embedded in the location of the bit d0. And, in the same way, it is possible to generate initial values including data of a pattern 2 consisting of the pattern 1 inverted. The pattern 1 or the pattern 2 generated like this is embedded in the initial values with a predetermined period. By repeating the embedding multiple times, erroneous detection becomes less likely. And if the pattern 1 and the pattern 2 are embedded alternately, even if data is recorded repeatedly in the same place, because data with different scrambling data added is recorded, the recording causes less damage.

On the reproduction side, when the initial values are detected, if it is known in advance that the pattern 1 is embedded in d0, the embedded information can be detected, but if the embedded location and pattern and period are not known in advance, the embedded information cannot be obtained. When as shown in FIG. 22 15-bit initial values are generated and scrambling data is generated on the basis of these and the lowest 8 bits are added to recording data, the method can be applied with only minor circuit changes being made to an existing DVD scrambling circuit and its initial values. In this case, the initial values shown in FIG. 6 become unnecessary, and instead a different initial value is generated and recorded on the disc each time recording is carried out.

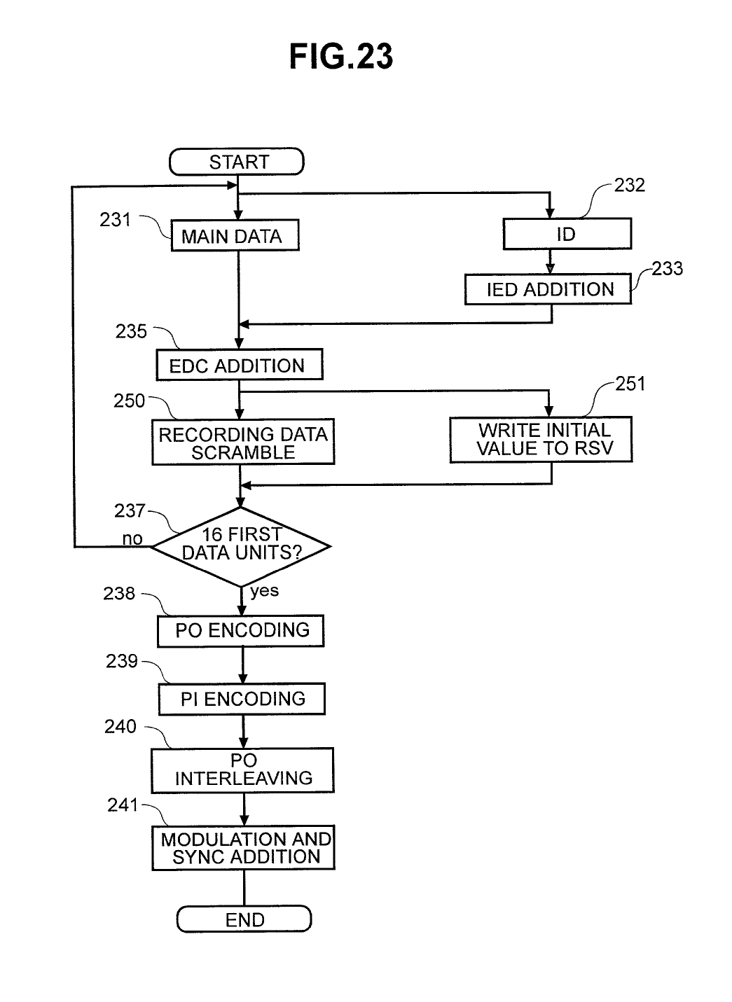

An example of processing steps for this is shown in FIG. 23. With respect to FIG. 19, by recording data scrambling being carried out in a step 250, ID, IED and main data are scrambled and simultaneously in step 251 the initial value is written in RSV (Reserve).

Here, with just pattern detection of a series of n bits of data, there is a certain probability of erroneous detection occurring. Consequently it is necessary to improve reliability by for example at the time of recording making either the length of the pattern long or regularly repeat-embedding it and also at the time of detection either confirming detection a consecutive number of times or at least confirming a number of detections within a fixed time. By this means, although it makes the detection time long, it is possible to prevent erroneous detection. This is combined with the data error correction result, and if correction is impossible then that bit is not applied to the determination or conversely it is determined to be either. And when the length of the specified pattern or the number of repetitions is changed in correspondence with the importance of the data, there are fewer erroneous detections of the important data, and data that can be detected in a short time can be controlled quickly. When embedded information is detected, although it is not illustrated in the drawings, the detection result may be displayed on a display device.

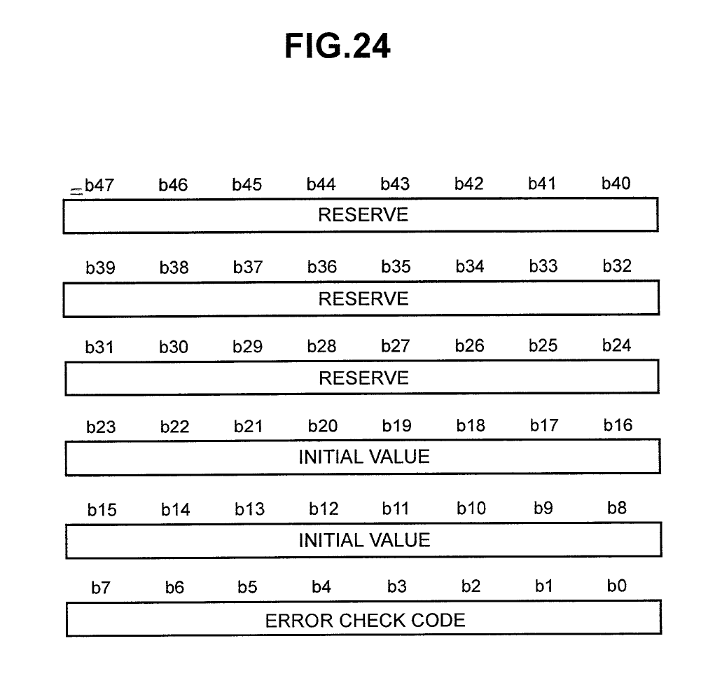

FIG. 24 shows an example of an area for recording initial values in a reserve area on the recording medium 2220.

In the example shown in FIG. 24, the 24 bits of b0 through b23 are used to record an initial value of scrambling data and a check code for detecting any error thereof.

Here, in this preferred embodiment, the area for recording the initial value was made the 16 bit area of b8 through b23 and the error check code was made the 8 bits of b0 through b7; however, the invention is not limited to this bit position, and any area in which an initial value of scrambling data can be recorded in at least one location will suffice. And, the area where the initial value of scrambling data and the error check code are recorded is not limited to RSV and can be any area in which data can be recorded. The initial value area is a 16-bit area for a 15-bit initial value shown in FIG. 22 provided with a 1-bit reserve, but the number of bits of the initial value and the error check code are not limited to these. Of course, alternatively an error check code may not be added. When the initial value is recorded in a RSV (Reserve) area like this, because descrambling is easier when the initial value is read first also on readout, in the kind of first data unit 305 shown in FIG. 3, the order of the RSV and the sector ID, IED may be interchanged.

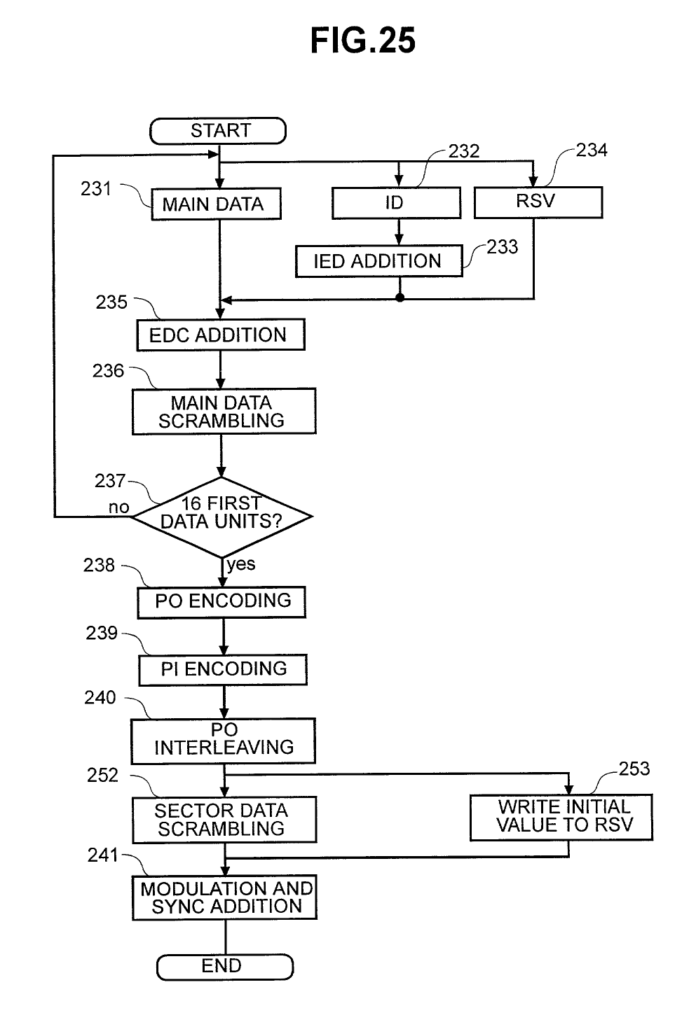

An example of processing steps of this time is shown in FIG. 25.

In the figure, with respect to FIG. 19, by the sector data scrambling of a step 252, the ID, IED and main data are scrambled and simultaneously, in step 253, the initial value is written to the RSV. By scrambling the data in this order, even when recording fails and the recording data is re-scrambled for recording again, it is not necessary for the error detection code to be re-encoded, and only the processing from the scrambling onward need be executed again.

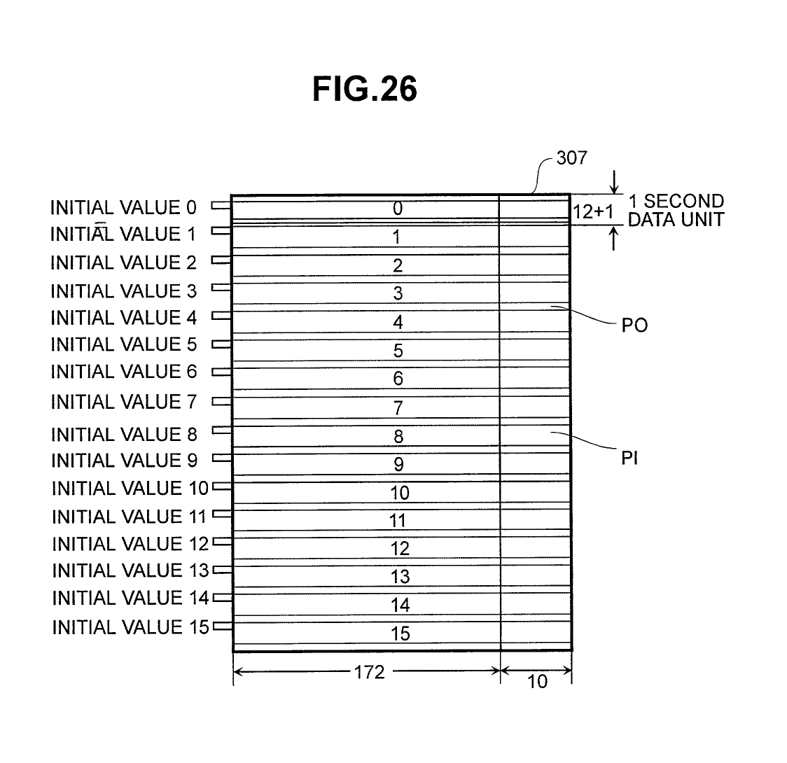

FIG. 26 shows an example of a case wherein initial values are added to the second data units of a DVD shown in FIG. 9.

In FIG. 26, here, to the heads of the 16 first data units shown in FIG. 9 are added initial values 0 through 15 to make second data units. Here, as shown earlier, by embedding a pattern like the pattern 1 or the pattern 2 shown in FIG. 22 in the initial values 0 through 15, it is possible to embed a series of 16 data. Of course, the number of units to which an initial value is added as shown here may be more or less than this, and in spacing also they need not to be consecutive and may be in predetermined locations. For example, the embedded information may be embedded only in the initial values of the even-numbered second data units. As for the location where the initial value is added, if the initial value is positioned in the vicinity of the data which is to be scrambled using that initial value and before the scrambling data, processing for using that initial value for descrambling can be carried out more easily. However, if a method is adopted wherein in advance the initial value is read first and stored, for example in a memory area provided for initial values, it needs not to be positioned in the vicinity.

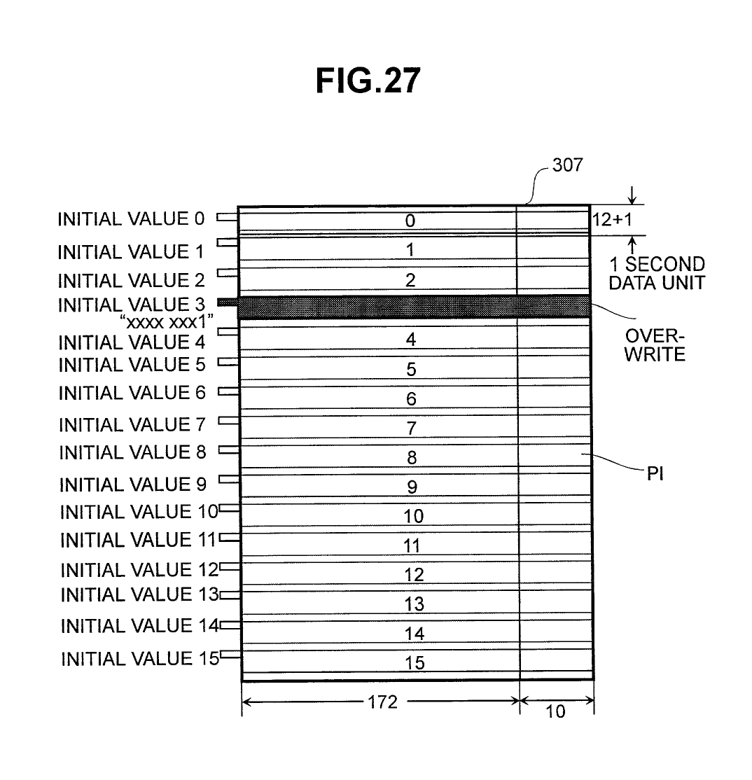

FIG. 27 is a view showing a case wherein overwriting is carried out to replace recording data only in part.

In the figure, for example when the main data of sector number 3 is to be rewritten and recorded in the same position, because when the embedded pattern is different it becomes impossible to detect the embedded information, the same value as the value of the pattern recorded previously is recorded. For example, if the pattern recorded previously is “xxxx xxx1”, then the d0 bit only is made the same, to give “xxxx xxx1” again, and for the other bits an initial value is generated with random numbers different from before. By this means, because when it has been modulated it is a different recording pattern, it is possible to record the embedded information while maintaining the effect of the scrambling.

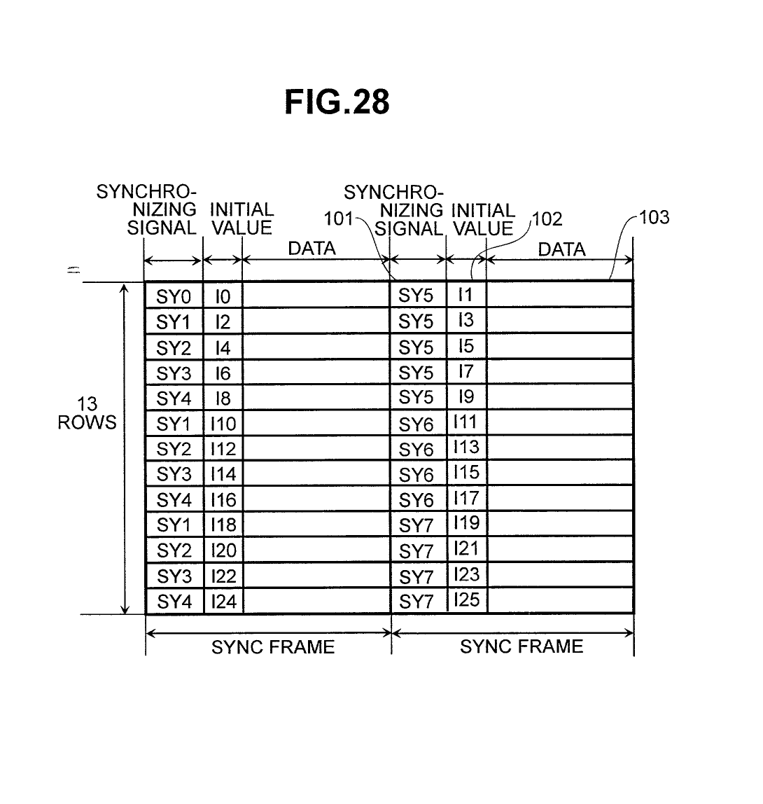

FIG. 28 is a view showing an example of the constitution of data when initial values have been added to third data units 308 of the constitution shown in FIG. 10.

In the figure, initial values of I0 through I25 are added after the synchronization signal and recorded together with the data. Here, as mentioned earlier, by embedding a pattern of the kind shown in FIG. 22 in the initial values of I0 through I25, it is possible to embed a series of 26 bits of data. Of course, the number of units to which an initial value is added as shown here may be more or less than this, and in spacing also they need not to be consecutive and may be in predetermined locations. For example, the embedded data may be embedded only in the initial values of the even-numbered SYNC frames.

Thus, using the example of an existing DVD data constitution an example of recording initial values has been described and a method for embedding a pattern in initial values has been shown; however, it is possible to embed a pattern in correspondence with the generation of pseudo-random numbers in any system wherein pseudo-random numbers are recorded on a recording medium along with recording data, and not just a DVD data constitution. The initial values are preferably recorded in units of scrambled data added scrambling data generated on the basis of those initial values, and are preferably recorded before the scrambled data.

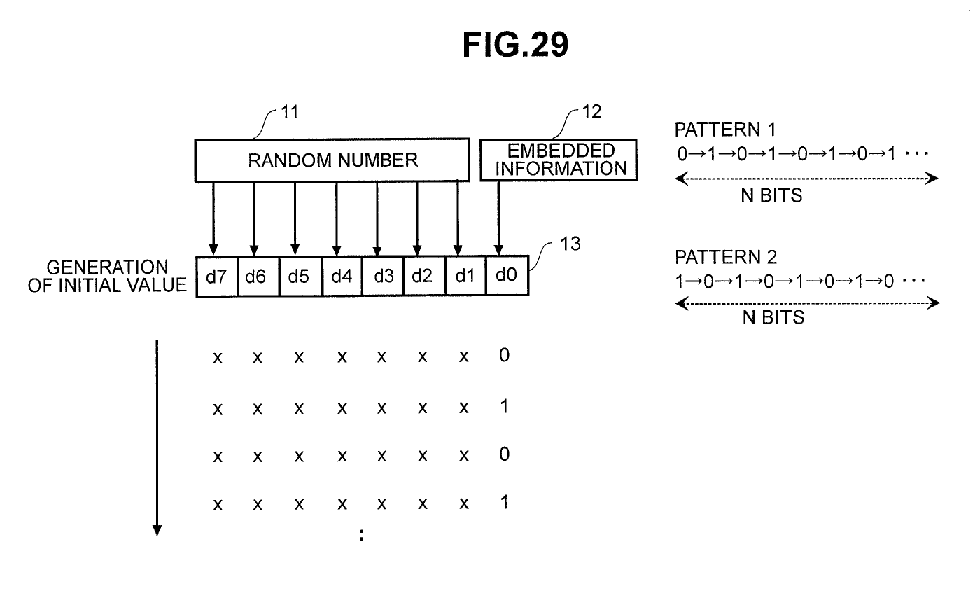

FIG. 29 is a view showing another example of the construction of the initial value generating block 2214 in FIG. 21.

This figure shows a case where embedded information is embedded in the least significant bit d0 in a case wherein 8-bit initial values are generated, but the number of bits of each initial value and the location, length and pattern of the embedded bits are not limited to those shown here. Each time initial value generation is performed, a random number 11 is generated and applied to the 7 bits of d1 through d7. Embedded information is applied to the bit d0 as for example a pattern 1 of a series of n data, and the first time “0” is applied and then “1” and then “0”, and so on. As a result, the generated initial values are generated as first “xxxx xxx0” then “xxxx xxx1” then “xxxx xxx0”, and so on (where x indicates either “0” or “1”). When n initial values have been generated like this, a series of n data is embedded in the location of the bits dO of these n initial values.

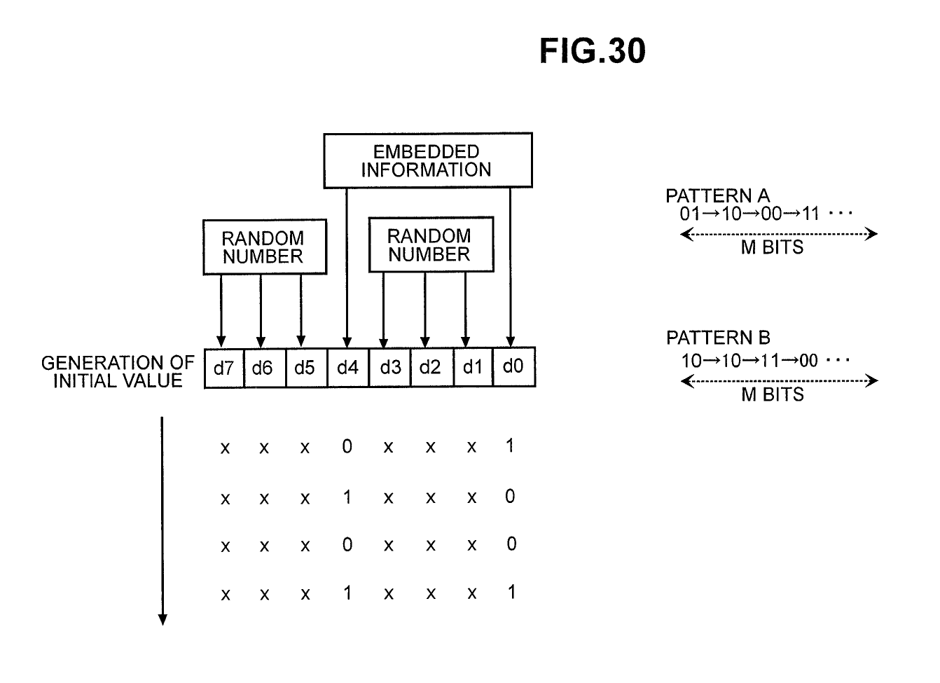

FIG. 30 shows another example of the construction of the initial value generating block 2214 in FIG. 21.

Here, bit d0 and bit d4 are made embedded information bits, and the remaining bits are for an initial value consisting of a random number. Of course, here also the location and number of embedded bits and the pattern and length of the embedded data are not limited to this. By embedding the bits d0 and d4 so as to make for example 01→10→00→11→ . . . like pattern a, it is possible to embed a 2-bit pattern in a single initial value. Also, the embedding location may be changed with time in a predetermined sequence, such as first embedding a pattern in the bit d0 and then embedding a pattern in the bit d4.

On the reproduction side, when the initial values are detected, if it is known in advance that a specified pattern is embedded in the bits d0 and d4, the embedded information can be detected, but if the embedded location and pattern and period are not known in advance, the embedded information cannot be obtained. Here, it may happen that only a pattern embedded in the bit d0 is known, or only a pattern embedded in the bit d4 is known, or both a pattern embedded in the bit d0 and a pattern embedded in the bit d4 are known. Because the information obtained is different in each of these cases, correspondingly different control can be executed, and different degrees of importance can be attached to the information. By this means it is possible to execute control combining multiple restrictions on factors such as recording/reproducing time, number of times, and quality.

And, by first transmitting an embedded pattern from the bit d0 to the reproducing system side and then changing to a pattern using the bit d4 as necessary, it is also possible to change the embedded information.

Here, an example wherein information is embedded in 2 bits of each initial value has been shown, but the number of bits is not limited to this. Also, when 8 bits are embedded in an 8-bit initial value, by changing the initial value generation sequence at a specified value it is also possible to make it have specified information.

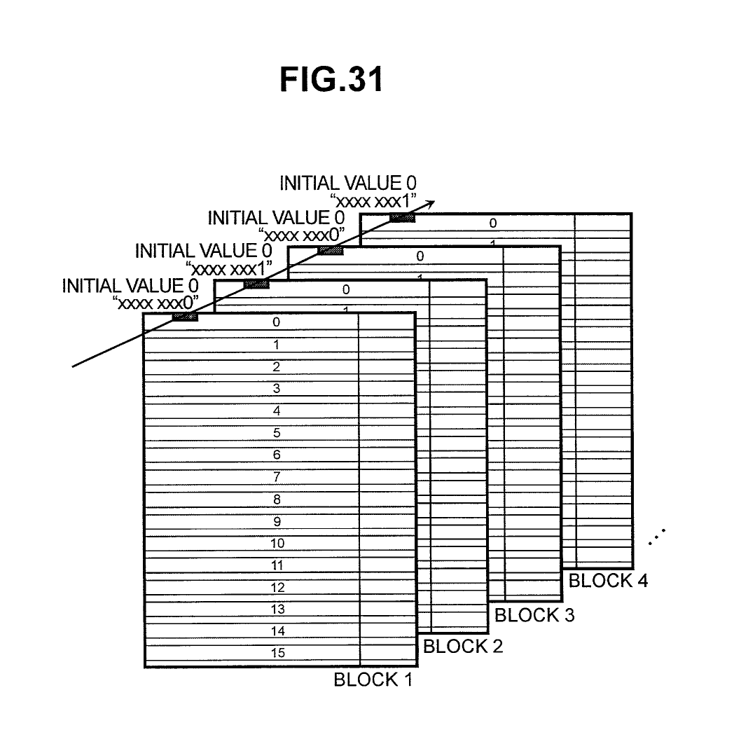

FIG. 31 shows an example of data constituted continuously in units of the ECC block shown in FIG. 9.

In the figure, at this time, if the initial values are to be recorded in RSV areas, a specified pattern can be constructed using the place of the recording sector, like the d0 bit of the initial value recorded in the RSV of block 1, the d0 bit of the initial value recorded in the RSV of block 2, the d0 bit of the initial value recorded in the RSV of block 3 and the d0 bit of the initial value recorded in the RSV of block 4. At this time, if the bits are inverted in the manner of “xxxx xxx0”, then “xxxx xxx1”, “xxxx xxx0”, even when random numbers generated by coincidence are the same, different initial values are generated and the scrambling data series generated can be made different.

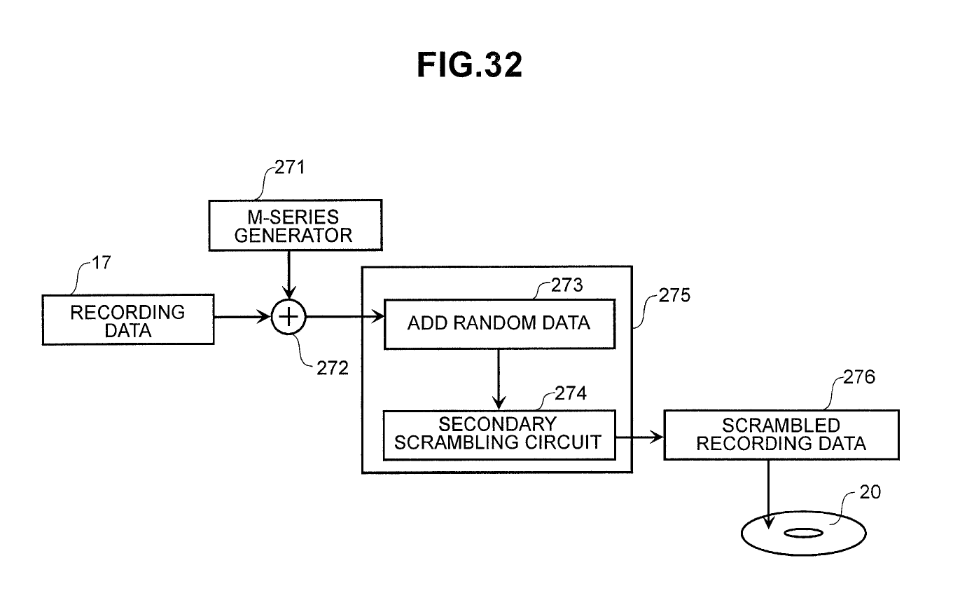

FIG. 32 illustrates another scrambling method according to the invention.

The method shown in FIG. 7 is a method wherein an M-series generator generates scrambling data using the initial values shown in FIG. 6, and a way of changing the initial value every time by a method similar to this was shown earlier. In the example shown in FIG. 32, random data is generated with an M-series generator 271 in advance and added to recording data 17 by an adder 272 to produce recording data with random data added 273. This recording data with random data added 273 is scrambled again by a secondary scrambling circuit 274 to produce scrambled recording data 276. The process of carrying out secondary scrambling 274 on data to which random data has been added will be called ‘guided scrambling’ 275.

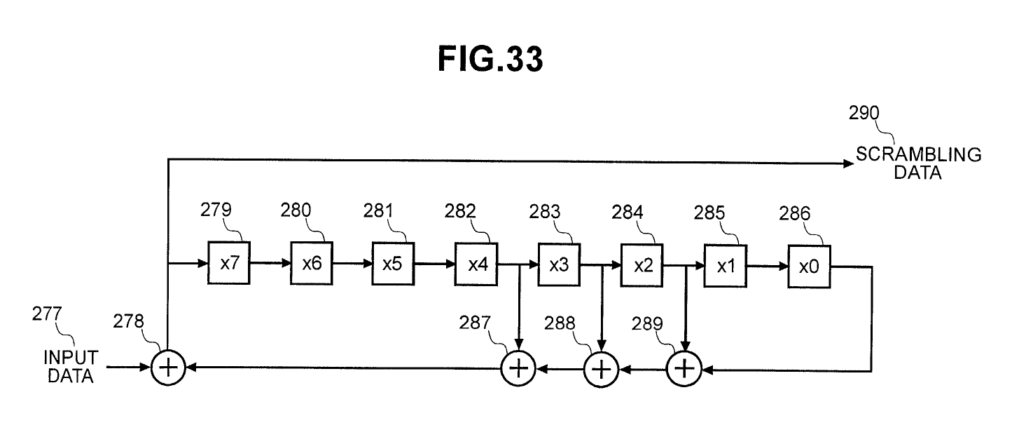

FIG. 33 shows an example construction of the guided scrambling 275 in FIG. 32. Here, scrambling data is generated on the basis of a primitive polynomial P(X)=X8+X4+X3+X2+1. In the figure, the reference number 277 denotes input data, and 279 through 286 denote registers which hold 1 bit of data and together constitute an 8-bit shift register. The reference numbers 278 and 287 through 289 denote adders, and 290 is generated scrambling data.

In the figure, 8 bits of random data are applied to the shift register as an initial value, and when the input data 277 is inputted, the scrambling data 290 is generated. With this method, the propagation of errors is kept down to 8 bits, and consequently even if the reproduction of an initial value fails, subsequent data can be decoded.

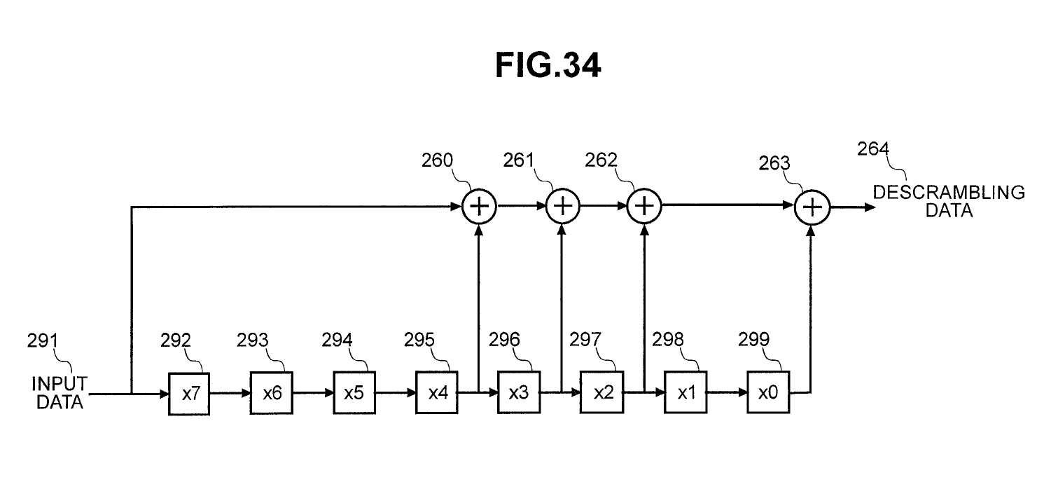

FIG. 34 shows an example of the construction of a decoder for the guided scrambling 275 in FIG. 32. Here, 291 denotes input data, and 292 through 299 are registers which hold 1 bit of data and together constitute an 8-bit shift register. The reference numbers 260 through 263 denote adders, and 264 decodes descrambled data.

In this figure, an 8-bit initial value is applied to the shift register, and when the input data 291 is inputted, descrambled data 264 is generated.

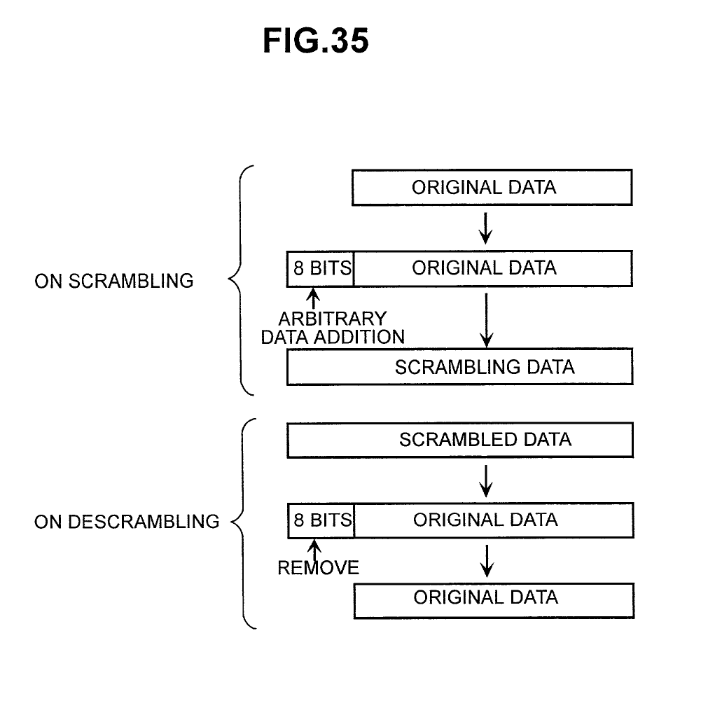

FIG. 35 is a view illustrating data constitutions of the scrambling and descrambling shown in FIGS. 32 through 34.

In this figure, at the time of scrambling, 8 bits of arbitrary data are added as an initial value to the original data to generate scrambling data, and at the time of descrambling the original data is generated from the scrambling data using the initial value and then the initial value is removed and the original data alone is passed on. By using this kind of scrambling and descrambling method, data exchange with little error propagation can be carried out, and because the initial value is added at the time of recording and removed on reproduction, it is difficult to analyze or tamper with.

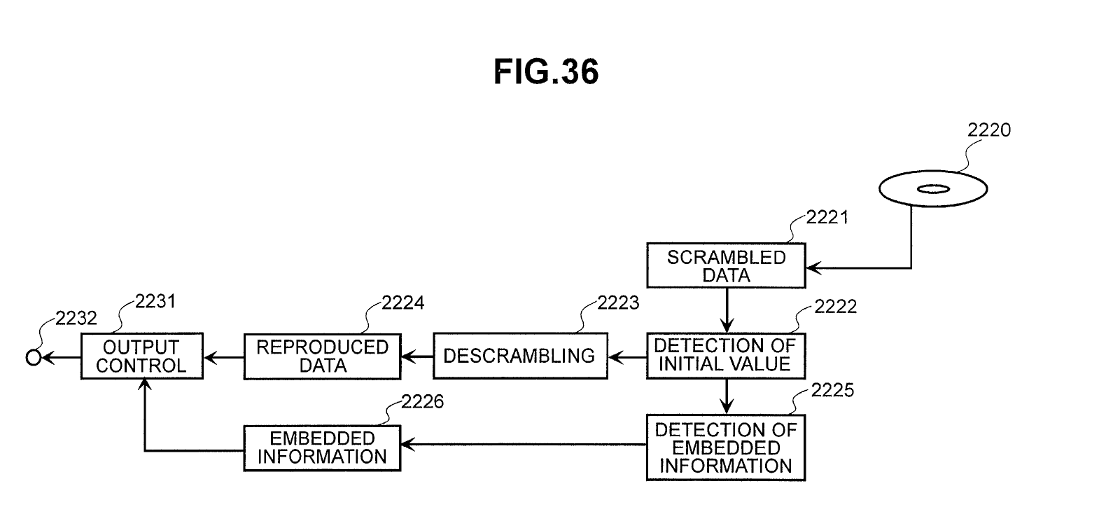

FIG. 36 shows an example of a system for controlling reproduced output with the reproduction system of FIG. 21. Here, 2231 denotes means for controlling output on the basis of detected embedded information, and 2232 is an output terminal.

Here, when the embedding method, that is, the embedding pattern and period and so on, is not correctly known, the embedded information cannot be embedded. Consequently, if the embedding method is only made known when an undertaking has been made to control correctly the embedding method of the embedded information, it can be judged that recording data recorded with embedded information added is recorded with control being carried out correctly with respect to control relating to the embedding of information. Therefore, it is possible to perform control correctly using this embedded information. And, restriction information relating to reproduction is included in the embedded information, and for example when the reproduction period or number of reproductions, or quality such as output rate or sampling frequency on reproduction, or with video the number of scan lines or compression ratio, is included, output accords with that. For example, when the embedded information cannot be read out, only one reproduction is allowed, but when an apparatus capable of detecting the embedded information is used and this is detected, it can be made possible to provide a service such that the number of reproductions can be increased. By doing this, embedded information having merit to the user can be added.

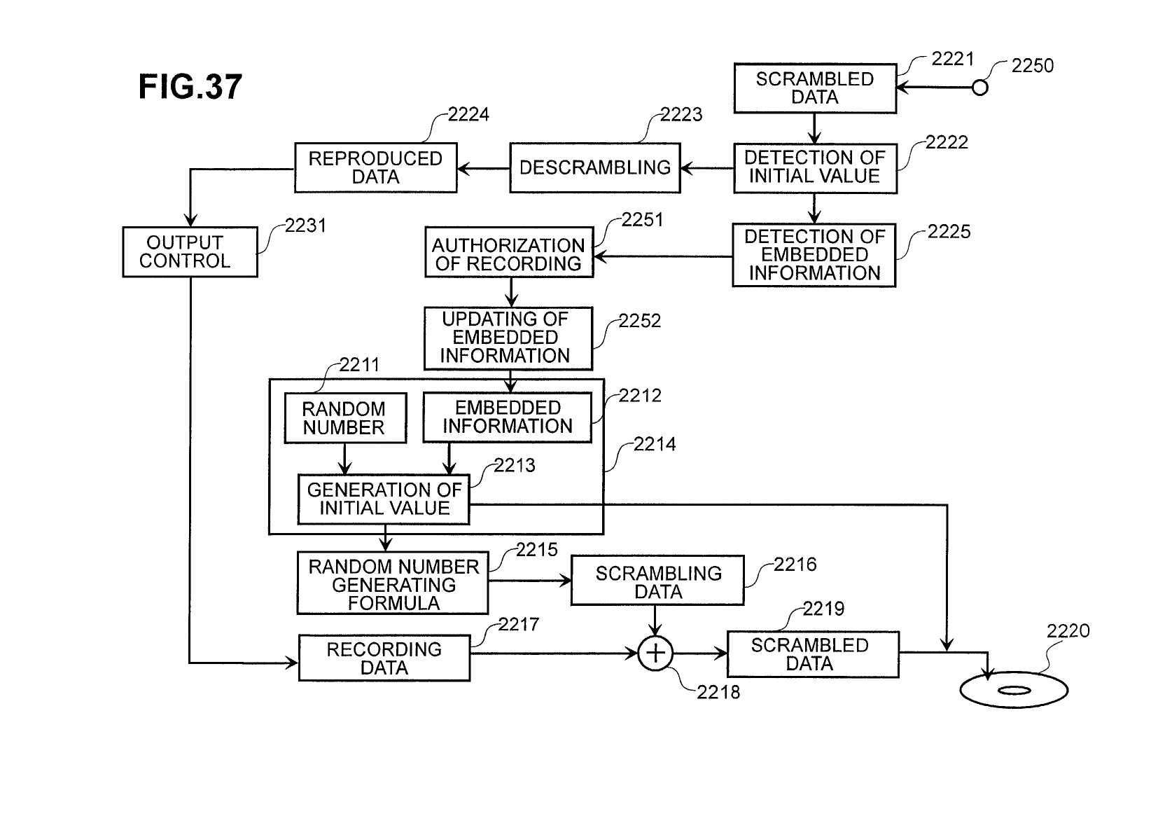

FIG. 37 shows an example of a system for detecting the embedded information described above and carrying out recording control on the basis of that information. Here, 2250 is an input signal such as reproduced data or a signal received by communication/transmission means of some sort, 2251 indicates that the detected embedded information is information authorizing recording, and by this means, when updating of the embedded information is necessary (for example when updating embedded information allowing only one recording/reproduction to embedded information allowing no more recording), the updated information is passed to an embedded information generating block 2214. The reproduced data 2224 and the recording data 2217 are normally the same, but because there are times when they differ, such as when the quality of the reproduced data 2224 is altered to make the recording data 2217, they are shown separately. And, output control 2231 is shown as control means for stopping the reproduced data 2224 being recorded. When embedded information detected by the embedded information detection 2225 is information authorizing one more recording, for example when recording is allowed up to twice, if embedded information indicating that it is a signal that has been recorded once has been added, because this signal can be recorded once more, record processing is carried out with the reproduced data 2224 as the recording data 2217. At this time, the next embedded information is made to show that recording has been carried out twice, and the embedded information is updated so that no further recording is possible. In the output control 2231, when the reproduced data 2224 is outputted as recording data 2217, if necessary, processing such as rate exchange of this recording data is carried out.

In the preferred embodiment described above, the case of a recording medium for DVD was described, but the invention is not limited to this, and can be applied to any information recording medium with which information recording is carried out by melting a recording film with heat from irradiation with an energy beam and changing its atomic arrangement. Also, the present invention can be applied when the recording medium is an optical card or the like. And as the beam used to produce heat and melt a recording film for recording, the invention is not limited to a laser beam and can be applied with any energy beam capable of melting a recording film. And when the beam is a laser beam, the wavelength and type of the laser beam are not limited by the invention. When a relatively short-wavelength laser such as a blue laser or an ultraviolet laser is used, high-density recording can be realized easily.

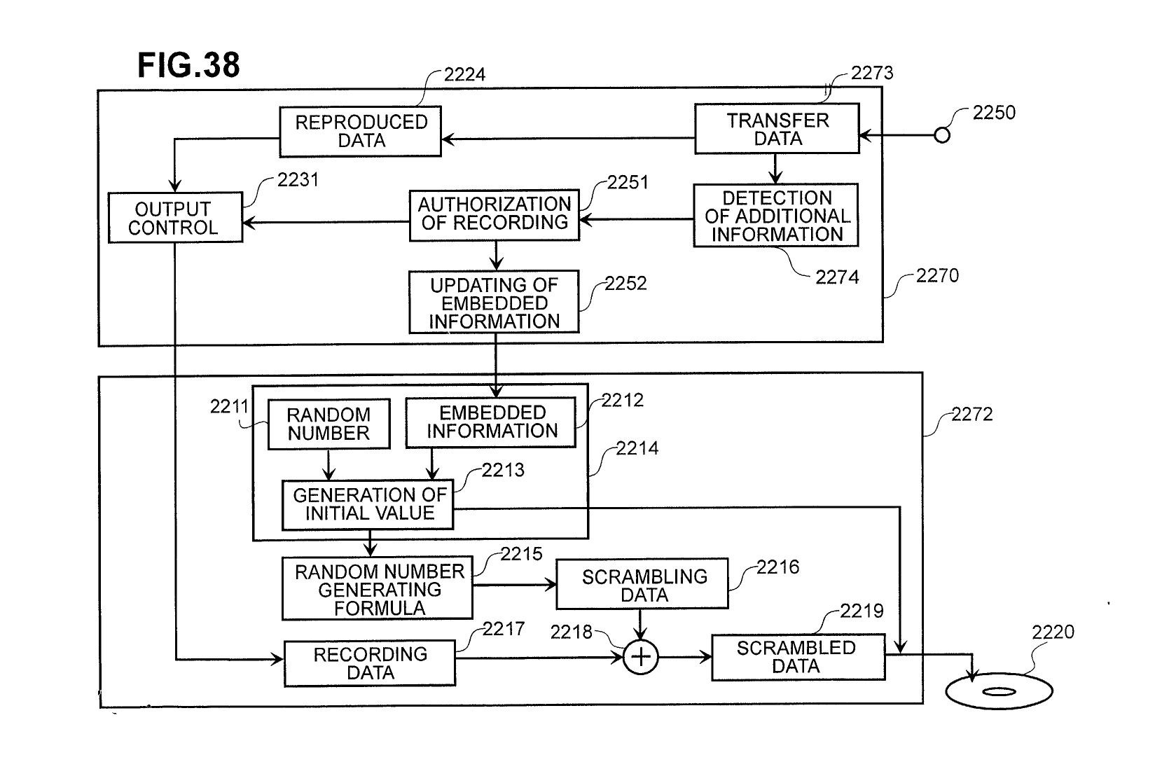

FIG. 38 shows reproducing and recording processing of a case wherein not only in a recordable recording medium recordable with the embedded information format described above but also for a pre-recorded medium recording is carried out with the same recording format and in data transfer also the same format is used. The reference number 2273 denotes transfer data, 2274 is added information detection, and the same embedded information detection is carried out. By this means, processing can be carried out by the same reproduction processing approach.

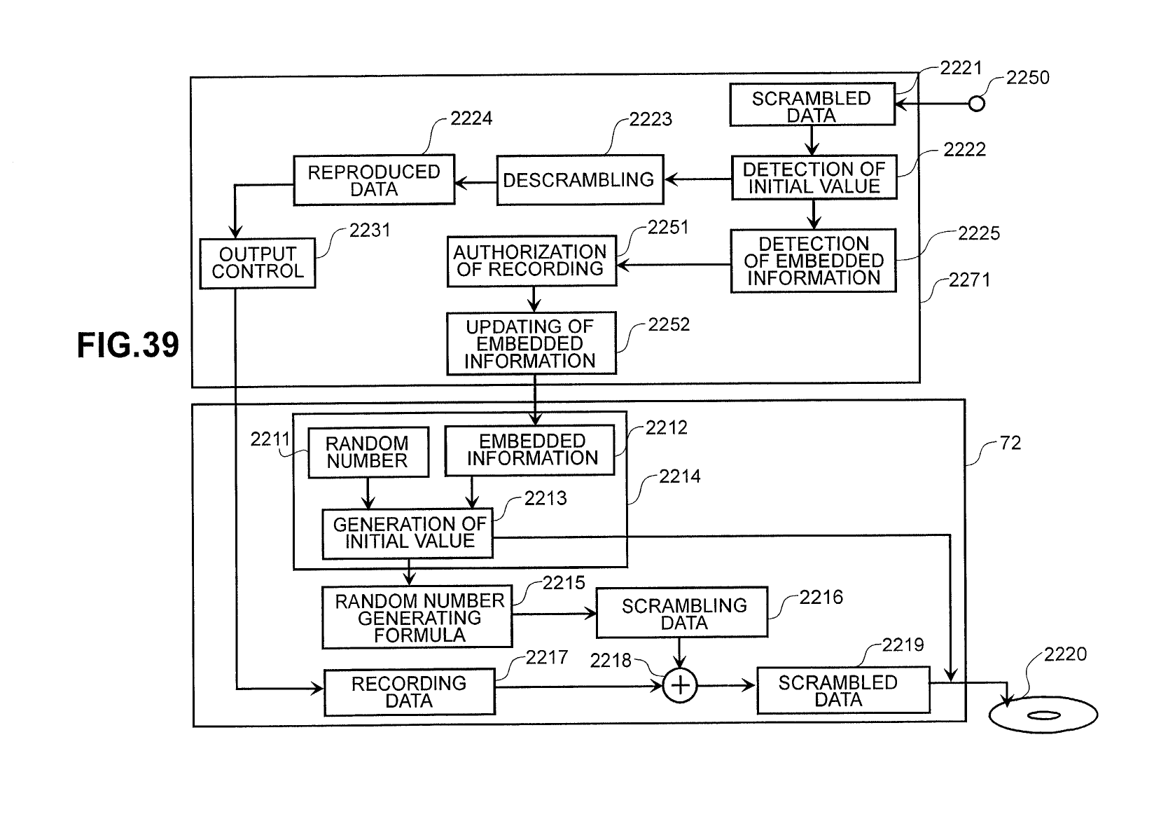

FIG. 39 is an example of the construction shown in FIG. 36 made into an integrated circuit. When the reproducing system and the recording system are built into the same construction like this to make everything from the detection of embedded information to the control of reproduced output into a reproduction signal processing integrated circuit 2271 as one block, the data becomes difficult to analyze. And when from the embedding of embedded information to the control of recording are made into a recording signal processing integrated circuit 2272 as one block, tampering with the processing part-way through is made impossible. And when a reproduced signal processing integrated circuit 2271 and a recording signal processing integrated circuit 2272 are made into one, that function is further raised.

Up to now, as the method of use of embedded information, the description has focused on control and authorization information for copyright protection; however, the invention is not limited to this. For example, if embedded information is made information such as recording start times and recording end times, program titles, and channels, it can be also used for so-called tape navigation. In particular, when it is recorded as G code, because correspondence with program information is also possible, it is easy to use.

And, the author of recorded data can also embed necessary information. That is, control of number and period of recordings, reproduction region restriction codes, recording and reproduction conditions, resolution, and compression or the like. And, it is also possible for information to be embedded by a setting carried out by the user making the recording. Set conditions of the time of recording can be embedded in a specified pattern. The manufacturer of a recording apparatus can also embed information. For example, a different number can be allocated to each recording apparatus and by embedding this as information it is possible to specify the device used to make a recording.

And, information relating to user usage facility can be put in the user data area, and information relating to management can be put in parts which are not user data area, such as disc management information.

As described above, with this invention, even when repeated writing operations are carried out, stable data recording can be carried out, and also a stable reproduced signal free of distortion or having its distortion well suppressed can be obtained.

And, initial values provided for conversion can be utilized to record additional information.

What is claimed is:

1. A data recording method for recording data on a rewritable recording medium, comprising the steps of: converting writing data to be written to the recording medium into data different from data already recorded in the same position on the recording medium; and
recording data on a rewritable recording medium.

2. A data recording method for recording data on a rewritable recording medium, comprising the steps of:
data-converting data to be recorded on the recording medium by superposing thereon information generated on the basis of data conversion information; and
recording the data conversion information and the data-converted data on the recording medium.

3. A data recording method according to claim 2, wherein said data conversion information is an initial value which is changed every recording.

4. A data recording method according to claim 3, wherein said initial value generates a pseudo-random number.

5. A data recording method according to claim 2, wherein additional information is embedded in a part of said data conversion information.

6. A data recording method according to claim 5, wherein in case a part of said data is rewritten, said additional information embedded in the data conversion information is made the same as before the rewriting.

7. A data recording method according to claim 1, wherein said data-converted data is main data, identification data, error detection code, and error correction code.

8. A data recording method according to claim 2, wherein said data-converted data is recorded in the vicinity of the recording position in which said data conversion information is recorded on said recording medium.

9. A data recording method for recording data on a recording medium which can be rewritten multiple times, comprising the steps of:
ordering the signal processing of data to be recorded on the recording medium in response to a received recording instruction;
adding error correction data to the data in response to the order;
data-converting the data thus added to by superposing thereon information generated on the basis of data conversion information;
modulating the converted data thus data-converted and the data conversion information;
recording the data conversion information to the recording medium; and
recording the converted data to the vicinity of the recording position in which the data conversion information was recorded.

10. A data recording method according to claim 9, wherein said data conversion information is an initial value which is changed every recording.

11. A data recording method according to claim 9, wherein additional information is embedded in a part of said data conversion information.

12. A data recording method according to claim 9, wherein said data-converted data is main data, identification data, error detection code, and error correction code.

13. A data reproducing method for reproducing from a recording medium, in which data conversion information and converted data data-converted by having superposed thereon information generated on the basis of the data conversion information are recorded, comprising the steps of:
reading the data conversion information;
generating information on the basis of the data conversion information;
restoring the converted data back to pre-conversion data of before the data-conversion, using the read data conversion information and the generated information; and
reproducing the pre-conversion data.

14. A data reproducing method according to claim 13, wherein said data conversion information is an initial value which is changed every recording.

15. A data reproducing method according to claim 13, wherein additional information is embedded in a part of said data conversion information.

16. A data reproducing method according to claim 15, further comprising the steps of detecting the additional information and controlling the reproduction of the pre-conversion data on the basis of the detection result.

17. A data reproducing method according to claim 16, wherein the detection is carried out a plurality of times and the reproduction of said pre-conversion data is controlled on the basis of those detection results.

18. A data reproducing method according to claim 17, wherein the detection is carried out for each of a plurality of pieces of additional information and the reproduction of said pre-conversion data is controlled on the basis of the results of detecting those pieces of additional information.

19. A data reproducing method according to claim 13, wherein said converted data is main data, identification data, error detection code, and error correction code.

20. A data recording apparatus for recording data on a rewritable recording medium, comprising:
a convertor for data-converting data to be recorded on the recording medium by superposing thereon information generated on the basis of data conversion information; and
a laser pickup for recording the data conversion information and the data-converted data on the recording medium.

21. A data recording apparatus according to claim 20, wherein said convertor superposes on the writing data other data having no correlation with the writing data and thereby converts the writing data into different data every writing operation.

22. A data recording apparatus according to claim 20, wherein said information generated on the basis of the data conversion information is generated from an initial value inputted to a shift register and changed every recording.

23. A data recording apparatus according to claim 22, wherein said initial value generates a pseudo-random number.

24. A data recording apparatus according to claim 20, wherein additional information is embedded in a part of said data conversion information.

25. A data recording apparatus according to claim 24, wherein in case said data is rewritten in part, said additional information embedded in the data conversion information is made the same as before the rewriting.

26. A data recording apparatus according to claim 20, wherein said data-converted data is main data, identification data, error detection code, and error correction code.

27. A data recording apparatus for recording data on a recording medium which is rewritable multiple times, comprising:
a microprocessor for ordering the signal processing of data to be recorded on the recording medium in response to a received recording instruction;
a signal-processing circuit for, in response to the order, adding error correction data to the data, data-converting the data thus added to by superposing thereon information generated on the basis of data conversion information, and modulating the converted data thus data-converted;
a laser generating source for generating a recording laser;
a laser pickup for irradiating the generated recording laser at the recording medium; and
a servo for controlling the laser pickup to record the data conversion information and the converted data.

28. A data recording apparatus according to claim 27, wherein said information generated on the basis of the data conversion information is generated from an initial value inputted to a shift register and changed every recording.

29. A data recording apparatus according to claim 27, wherein additional information is embedded in a part of said data conversion information.

30. A data recording apparatus according to claim 27, wherein said data-converted data is main data, identification data, error detection code, and error correction code.

31. A data reproducing apparatus for reproducing from a recording medium in which data conversion information and converted data data-converted by having superposed thereon information generated on the basis of the data conversion information are recorded, comprising:
a laser pickup for reading the data conversion information and the converted data;
a signal-processing circuit for using the read data conversion information and the information generated on the basis of the data conversion information to restore the converted data back to pre-conversion data of before the data-conversion; and
reproducing apparatus for reproducing the pre-conversion data.

32. A data reproducing apparatus according to claim 31, wherein said data conversion information is an initial value changed every recording.

33. A data reproducing apparatus according to claim 31, wherein additional information is embedded in a part of said data conversion information.

34. A data reproducing apparatus according to claim 33, wherein said additional information is detected by a detector and the reproduction of the pre-conversion data is controlled on the basis of the detection result.

35. A data reproducing apparatus according to claim 34, wherein the detection is carried out a plurality of times and the reproduction of said pre-conversion data is controlled on the basis of those detection results.

36. A data reproducing apparatus according to claim 35, wherein the detection is carried out for each of a plurality of pieces of additional information and the reproduction of said pre-conversion data is controlled on the basis of the results of detecting those pieces of additional information.

37. A data reproducing apparatus according to claim 31, wherein said converted data is main data, identification data, error detection code, and error correction code.

38. A data recording method for use with a rewritable recording medium, comprising the steps of:
comparing first data already recorded in a write position on the recording medium with second data to be newly written to the same write position, on data writing; and
writing the second data to the write position in case the result of the comparison is that the first data and the second data include different data.

39. A data recording method for use with a rewritable recording medium, wherein in case writing data of management information to be recorded to a position on the recording medium includes the same data as data already written in the same position on the recording medium, the writing data is not recorded with respect to the parts where the data is the same.

40. A data recording apparatus for recording data on a rewritable recording medium, wherein management information of writing data to be recorded on the recording medium is temporarily stored in a separate memory and written to the recording medium when the recording medium is removed from the apparatus.

41. A data recording apparatus for recording data on a rewritable recording medium, comprising means for superposing known data on management information of writing data to be recorded to the recording medium, wherein it is recorded as different management information data on every recording operation.

42. A data recording apparatus for use with a rewritable recording medium, wherein on data writing first data already recorded in a writing position on the recording medium and second data to be newly written to the same writing position are compared and in case the first data and the second data include different data, the second data is written to the write position.

43. A data reproducing apparatus for reproducing data from a recording medium on which data converted to a predetermined format has been recorded, comprising output means for, in case a known data series is detected from data having undergone a reverse-conversion of the format, deeming the data series to be invalid data and not outputting it as reproduction data, and output means for outputting a flag indicating that the data is invalid.
